(19) United States
(12) Patent Application Publication
(10) Pub. No.: US 2026/0067716 A1
(43) Pub. Date: Mar. 5, 2026

(54) Method for UE assisted AIML-based proactive context-aware optimization in next generation cellular networks to enable emerging machine type applications

(71) Applicant: InterDigital Patent Holdings, Inc., Wilmington, DE (US)

(72) Inventors: Subhramoy Mohanti, Santa Clara, CA (US); Azuka Chiejina, Fairfax, VA (US); Hyomin Choi, Sunnyvale, CA (US); Fabien Racape, San Francisco, CA (US); Shahab Hamidi-Rad, Sunnyvale, CA (US)

(73) Assignee: InterDigital Patent Holdings, Inc., Wilmington, DE (US)

(21) Appl. No.: 18/826,008

(22) Filed: Sep. 5, 2024

(51) Int. Cl. H04W 24/02; H04W 4/70; H04W 24/08; H04W 28/02

(52) U.S. Cl. CPC H04W 24/02; H04W 4/70; H04W 24/08; H04W 28/0268

(57) ABSTRACT

An example method performed by a Wireless Transmit/Receive Unit (WTRU) is described. The method comprises determining context information for execution of an edge-assisted task associated with a machine-type-communications (MTC) application, sending the context information, receiving one or more context-aware parameters and information related to usage of the one or more context-aware parameters, determining a configuration for at least one of an application layer or an upper network (NW) layer based on the received information, and sending a first uplink (UL) transmission using the one or more context-aware parameters for the application layer or the upper NW layer based on the determined configuration. The context information may indicate one or more of performance of the MTC application or performance of the edge-assisted task.

### BACKGROUND

Machine-type-communications (MTC) allows machines/devices to interconnect wirelessly with little or no human intervention, thereby forming a network of connected devices, which may include sensors, actuators, self-driving cars, and so on.

### SUMMARY

An example method performed by a Wireless Transmit/Receive Unit (WTRU) is described. The method comprises determining context information for execution of an edge-assisted task associated with a machine-type-communications (MTC) application. The context information indicates one or more of performance of the MTC application or performance of the edge-assisted task. The method further comprises sending the context information. The method further comprises receiving one or more context-aware parameters and information related to usage of the one or more context-aware parameters. The method further comprises determining a configuration for at least one of an application layer or an upper network (NW) layer based on the received information. The method further comprises sending a first uplink (UL) transmission using the one or more context-aware parameters for the application layer or the upper NW layer based on the determined configuration.

In examples, the method further comprises sending a second UL transmission using one or more default parameters for the application layer or the upper NW layer based on the determined configuration. In examples, the context information indicates a request for machine learning based context-aware optimization for the MTC application. In examples, the method further comprises sending a request for machine learning based (ML-based) context-aware optimization for the MTC application, where receiving the one or more context-aware parameters is in response to sending the request. In examples, the method further comprises sending an indication of at least one of: when to trigger the ML-based context-aware optimization, or a requested duration for the ML-based context-aware optimization. In examples, the received information indicates at least one of a duration or a number of slots for applying the one or more context-aware parameters. In examples, receiving the information is via downlink control information (DCI), a medium access control control element (MAC CE), or radio resource control (RRC) signaling. In examples, the received information further indicates whether to use the one or more context-aware parameters or one or more default parameters for the first UL transmission based on one or more of application task quality of service (QoS) requirements, WTRU environment, WTRU mobility, WTRU power consumption, wireless channel condition, or measured QoS indicated in the context information. In examples, the one or more context-aware parameters are associated with a predicted application configuration to achieve an end-to-end (E2E) quality of service (QoS) for a requested duration indicated by the context information. In examples, sending the first UL transmission is based on using the one or more context-aware parameters in the application layer and one or more upper NW layers. In examples, the method further comprises executing the edge-assisted task. In examples, the performance of the MTC application includes at least one of a time span from data generation to inference feedback, a threshold for the time span, an upper bound of a data rate, a lower bound of the data rate, or a data size. In examples, the performance of the edge-assisted task includes at least one of an inference confidence level, an inference confidence threshold, or false positives associated with inference decisions. In examples, the context information further indicates one or more of compute performance, network (NW) layer performance, or WTRU performance. In examples, the one or more context-aware parameters include one or more NW layer configuration parameters or one or more application layer configuration parameters. In examples, the one or more NW layer configuration parameters comprise one or more of: number of uplink slots in a physical layer (PHY) frame, number of downlink slots in the PHY frame, transmit power, bandwidth, time division duplexing, frequency division duplexing, time domain resource allocation, or frequency domain resource allocation. In examples, the one or more application layer configuration parameters comprise one or more of: data rate, data compression, or data priority.

An example Wireless Transmit/Receive Unit (WTRU) comprising a processor is described. The processor is configured to determine context information for execution of an edge-assisted task associated with a machine-type-communications (MTC) application. The context information indicates one or more of performance of the MTC application or performance of the edge-assisted task. The processor is further configured to send the context information. The processor is further configured to receive one or more context-aware parameters and information related to usage of the one or more context-aware parameters. The processor is further configured to determine a configuration for at least one of an application layer or an upper network (NW) layer based on the received information. The processor is further configured to send a first uplink (UL) transmission using the one or more context-aware parameters for the application layer or the upper NW layer based on the determined configuration.

In examples, the processor is further configured to send a second UL transmission using one or more default parameters for the application layer or the upper NW layer based on the determined configuration. In examples, the context information indicates a request for machine learning based context-aware optimization for the MTC application. In examples, the processor is further configured to send a request for machine learning based (ML-based) context-aware optimization for the MTC application, where receiving the one or more context-aware parameters is in response to sending the request.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a system diagram illustrating an example use case for MTC in an edge-assisted smart surveillance application.

FIG. 3 is a block diagram illustrating an example of an edge-assisted machine-type application workflow.

FIG. 4 is a block diagram illustrating an example of time domain resource assignment from a network (NW) to a WTRU in fifth generation (5G) new radio (NR).

FIG. 5A is a block diagram illustrating an example of dynamic scheduling in 5G NR.

FIG. 5B is a block diagram illustrating an example of Type 1 configured scheduling (CS) in 5G NR.

FIG. 5C is a block diagram illustrating an example of Type 2 CS in 5G NR.

FIG. 6 is a block diagram illustrating an example of frequency domain resource assignment for WTRUs in 5G NR.

FIG. 7 is a block diagram illustrating an example of 5G NR physical layer (PHY) frame structure with 30 kilohertz (kHz) sub-carrier spacing (SCS).

FIG. 8 is a block diagram illustrating an example uplink transmission process in 5G NR time division duplex (TDD) configuration with 30 KHz SCS.

FIG. 9 is a block diagram illustrating an example of 5G NR PHY layer latency in TDD with 30 kHz SCS and a frame configuration that includes seven downlink slots (7DL), two uplink slots (2UL), and one flexible slot (1F).

FIG. 10 is a system diagram illustrating an example use case for edge-based object classification and car license plate identification for intelligent surveillance.

FIG. 11 is a diagram illustrating an example scenario depicting priority of a video frame based on machine-type tasks, such as object detection and license plate identification.

FIG. 12 is a diagram illustrating an example scenario for estimating a threshold for round-trip time of video frame generation to interference feedback reception from a remote server for a machine-type task such as intelligent surveillance.

FIG. 13A is a diagram illustrating a first example scenario for the dynamic nature of QoS in a machine-type application due to WTRU environment characteristics.

FIG. 13B is a diagram illustrating a second example scenario for the dynamic nature of QoS in a machine-type application due to WTRU environment characteristics.

FIG. 14 is a system diagram illustrating an example cellular network environment that includes multiple mobile WTRUs running MTC application(s) and connected to a NW.

FIG. 15 is a block diagram illustrating an example of a deep Q-network (DQN) reinforcement learning agent architecture for context-aware optimization in the WTRU and the cellular network across NW and application layers.

FIG. 16 is a block diagram illustrating an example of deep reinforcement learning (DRL) network architecture for context-aware optimization in the WTRU and the cellular network across the NW and application layers.

FIG. 17 is a graph diagram illustrating an example performance of the proposed DRL agent represented by total rewards per episode during training of context-aware optimization for a single mobile user according to different latency requirements.

FIG. 18A is a graph diagram illustrating a first example of the performance of the proposed DRL agent compared to a legacy 5G NW optimization in terms of latency for emerging machine type applications in a mobile environment.

FIG. 18B is a graph diagram illustrating a second example of the performance of the proposed DRL agent compared to a legacy 5G NW optimization in terms of latency for emerging machine type applications in a mobile environment.

FIG. 19 is a flowchart illustrating an example of WTRU assisted context-aware optimization in a cellular network across NW and application layers to accommodate dynamic and custom machine type application QoS requirements.

FIGS. 20A, 20B, and 20C is a flowchart diagram illustrating example operations for WTRU assisted context-aware optimization in a cellular network of the NW and application layers to accommodate dynamic and custom machine type application QoS requirements.

### DETAILED DESCRIPTION

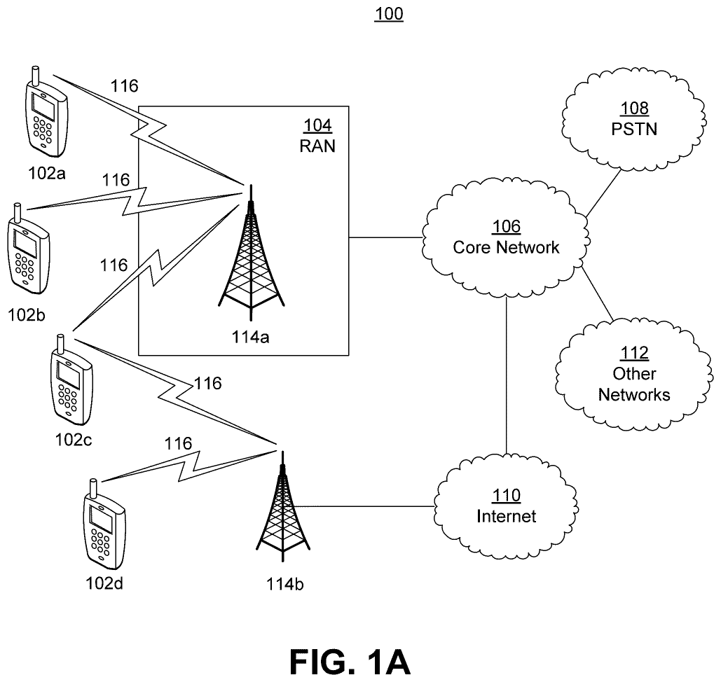

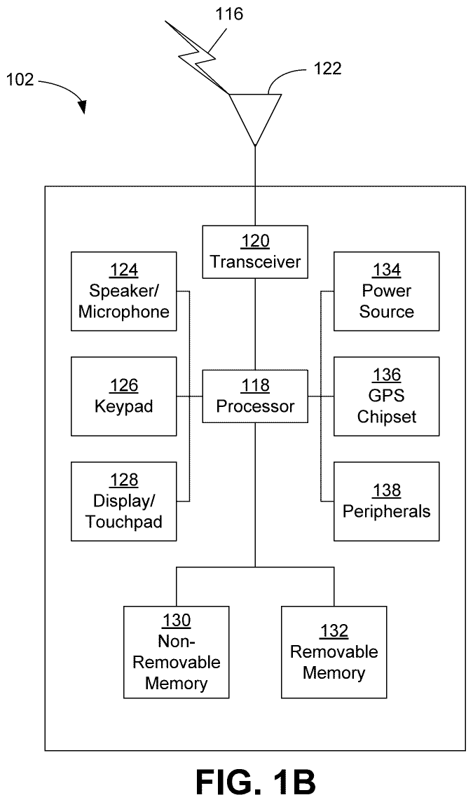

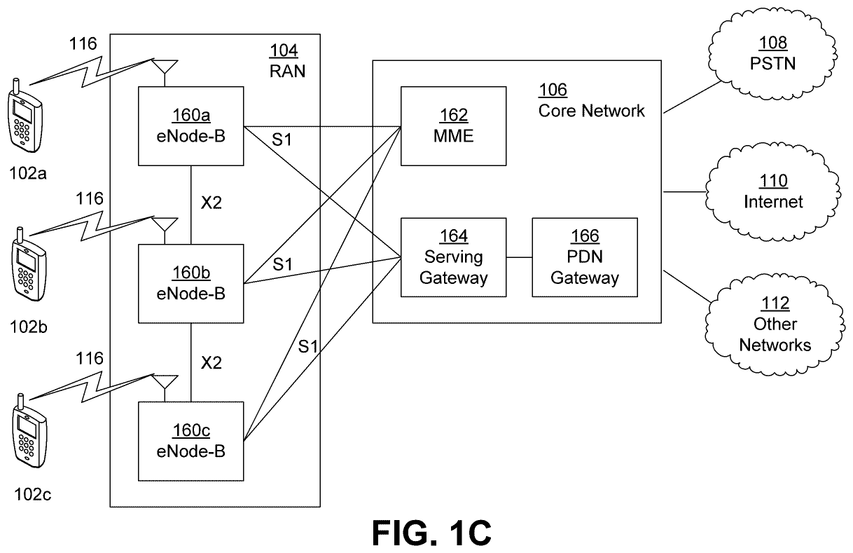

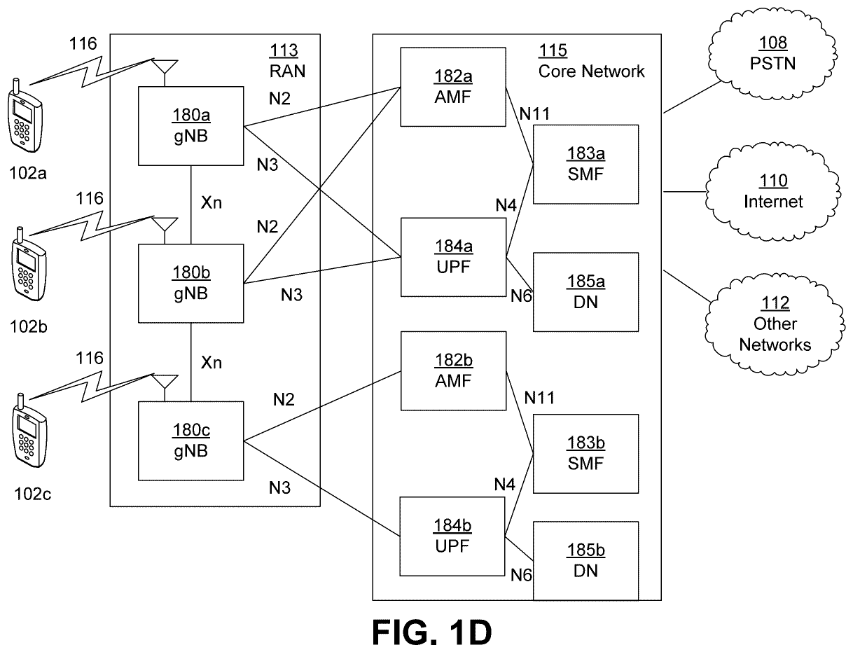

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network. In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Cellular networks (e.g., 5G) may be a key enabler for MTC due to their ubiquitous presence provides widespread coverage and mobility support, large bandwidth, and edge computing capabilities. Several internal features and configurations within the 5G protocol stack may support MTC applications as well (e.g., flexible numerology, flexible allocation of uplink and/or downlink resources). Requirements of an edge-assisted navigation machine task, for example, may include various machine-type sub-tasks, such as object detection and classification, path planning, situational awareness, tracking/following a target vehicle, precision localization, and/or mapping.

Example use cases for MTC are described herein such as, for instance, edge-assisted smart surveillance.

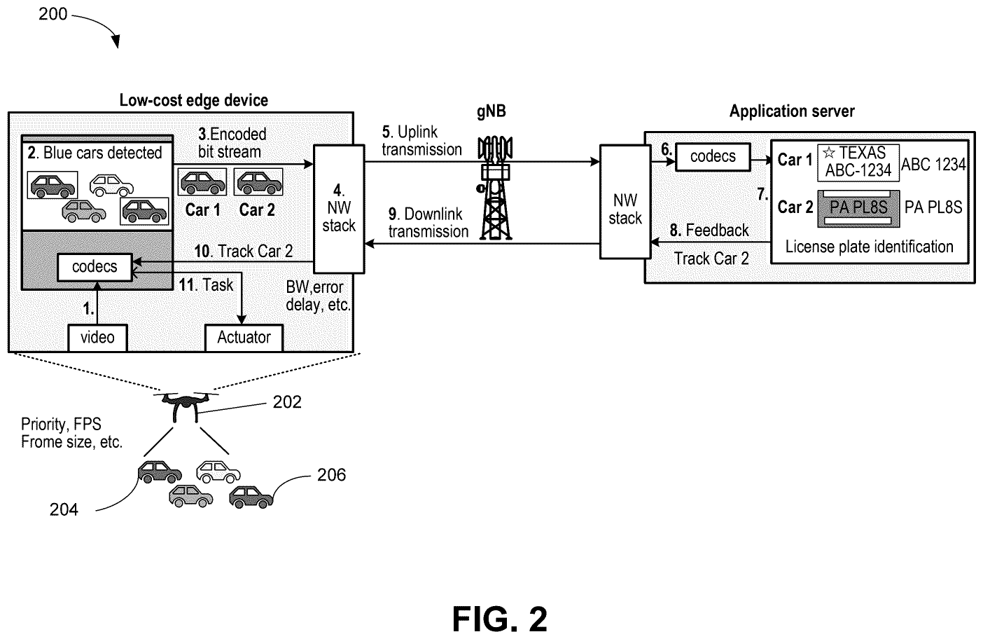

FIG. 2 is a diagram 200 illustrating an example scenario for an edge-assisted machine type task (e.g., smart surveillance). In this example use-case scenario of edge-assisted smart surveillance, a multi-modal sensor enabled connected smart device/UE (e.g., drone, vehicle, etc.) monitors an area of interest using its sensors (e.g., video camera, lidar, etc.). The example machine-task is to monitor the area of interest for cars that match a specific license plate number and follow the car once it has been identified. A connected WTRU is assisted by an edge server over the next-generation network (NW) to carry out the security sensitive and compute intensive processes of smart surveillance (e.g., license plate identification) after receiving the sensed data inputs from the WTRU. This process can be executed through a multi-step approach as shown in FIG. 2. In Step 1, the WTRU captures (e.g., detects) events in its surrounding through its sensors and generates data (e.g., video frames). In Step 2, a local artificial intelligence (AI)/machine learning (ML) application on the device may use the data to perform the first part of the machine-task (e.g., object detection and/or classification). In Step 3, if some object detection/classification thresholds are met (e.g., high confidence threshold of blue cars detected. The WTRU 202 (e.g., edge device) may then encode application data that corresponds to cars 204, 206 (e.g., “Blue cars detected”, “Car 1”, “Car 2”, etc.) into bitstreams.

The encoded bitstreams are carried over the NW stack in Step 4. In Step 5, the WTRU 202 transmits the encoded bitstreams as uplink transmission to the NW via the gNB. The NW forwards the data (e.g., encoded bitstreams) to the application server in Step 6. The application server may include application codecs configured to decode the data and perform follow-on AI/ML machine-tasks in Step 7 (e.g., license plate identification) using the decoded data. Based on the inference results and performance (e.g., high confidence level of positive identification of license plate data), the application server generates the proper machine-task feedback (e.g., track and follow a car with a specific license plate) in Step 8 and encodes the data. The application server then transmits this feedback data over the NW to the smart device 202 as downlink transmission in Step 9. In Step 10, the device (e.g., WTRU 202) extracts the machine-task information from the feedback data. In step 11, the device (e.g., WTRU 202) may then perform one or more AI/ML tasks (e.g., object tracking) and/or device actuator function initiations (e.g., updating speed, direction, etc.) to follow the target vehicle.

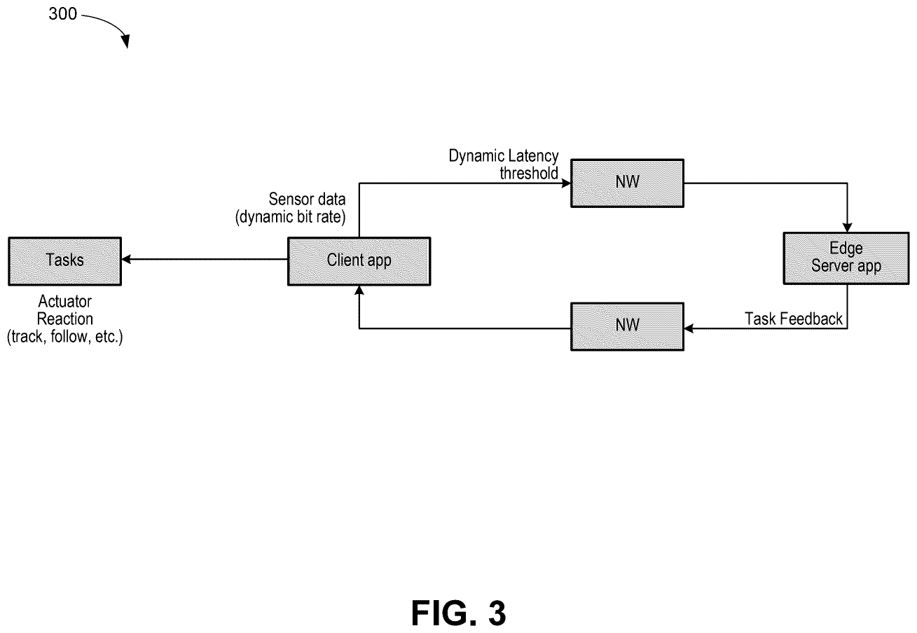

FIG. 3 is a diagram 300 that illustrates an example workflow for an edge-assisted machine-type application, such as the example edge-assisted MTC application 200. The edge-assisted task can be generalized as a client app running on an autonomous entity/WTRU (e.g., robots, cars, unmanned aerial vehicles, unmanned ground vehicles, etc.) that offloads sensor data to edge servers via the network, for running compute-intensive AI/ML based inference such as object detection, classification, tracking, etc. The edge server provides the inference decision feedback to the client application via the network (e.g., in a timely manner). Based on the inference result (e.g., object classified as a car, detected at a specific distance and heading in a specific direction), the client application can generate action(s) for the autonomous entity (e.g., changing speed and direction to avoid collision, etc.). For example, key performance indicators for the machine-type applications may be characterized by a round trip time (e.g., from sensor data generation to inference feedback reception), throughput, etc., which may depend on the type of task (e.g., object detection may require transmission of a lower amount of application data per unit of time compared to object classification and/or tracking), the WTRU environment (e.g., the number of objects around the WTRU, object behavior such as static or mobile, atmospheric conditions, etc.), and/or WTRU behavior (e.g., mobility, direction, etc.).

Example fundamental differences between human-type applications and machine-type applications are described herein. The network demands of legacy human-type communications, exemplified by applications such as video streaming, differ fundamentally from those of MTC, such as edge-assisted object detection and tracking for mobile robots.

Understanding these differences is critical for designing and optimizing 5G networks to cater to both communication categories effectively.

Example human type communications are described herein. Human-type communications have traditionally dominated network traffic, with video streaming being one of the most bandwidth-intensive applications. Generally, for human type communications, quality of service (QoS) is measured in terms of video resolution, frame rate, and/or buffering times, emphasizing minimizing delays and interruptions. Modern video streaming technologies can adapt to varying network conditions by adjusting the video quality dynamically (e.g., reducing resolution or bitrate). For instance, buffering techniques and adaptive streaming protocols could help mitigate latency issues, ensuring a smooth playback experience even over fluctuating network conditions. Every frame of video contributes equally to the overall viewing experience. Loss or corruption of even a small portion of the data (e.g., a few frames) can degrade the perceived quality, leading to interruptions or pixelation. Thus, packet loss and jitter may be critical parameters that impact the quality of video delivery. The traffic generated by video streaming is typically asymmetric, with a higher volume of data flowing from the server to the client (downlink).

Example machine-type communications (MTC) are described herein. In contrast to human type communications, emerging MTC applications, such as edge-assisted object detection and tracking for autonomous vehicles and mobile robots, present distinct network demands. MTC applications may generate substantial uplink traffic such as raw sensor data, including images and videos. This data may be transmitted from robots, for example, to edge servers for processing. The processed information, although less voluminous, may then be sent back to the robots, so that the robots can undertake follow-on actions. In some examples, real-time object detection and/or tracking may require near-instantaneous data transmission and processing to enable timely decision-making and actions by mobile robots. Thus, the utility of data in MTC may be closely tied to its timeliness, because delayed data could render high-utility information obsolete, particularly in dynamic environments.

In some scenarios, certain data segments in MTC may have higher priority, such as data capturing an object in the robot's path for example, which may be crucial for navigation and collision avoidance. The traffic patterns for MTC applications may exhibit high variability and bursts, driven by the episodic nature of sensing and control operations. In real-life scenarios, MTC data may be event-driven, with the importance of data spiking during critical events, such as the detection of an obstacle. Thus, in some scenarios, not all data generated by sensors is of equal importance. For example, data related to significant environmental changes may have higher utility than static or redundant information. Therefore, efficient data prioritization and compression techniques such as those proposed herein may be necessary and/or may enable an example system to ensure that the most relevant data is transmitted and processed first. Therefore, unlike video streaming, MTC applications may have event-based data prioritization and/or stringent latency requirements, since these metrics can significantly impact the functionality and safety of autonomous vehicles and robotic operations.

Example challenges for the example MTC use case of edge-assisted navigation are described herein.

As a first example challenge, end-to-end (E2E) latency may be affected by application (App) server performance which may not be under network control. During the course of executing an edge-assisted machine task, for example, the application server status may vary between available and lightly loaded, available and heavily loaded, and/or unavailable. This could result in edge inference quality and timeliness issues, which in turn may impact application round trip time and ultimately machine task performance (e.g., missed opportunity to track and follow a car, in the smart surveillance example, because feedback appeared late after the car has moved out of the smart device field of view for instance).

As a second example challenge, the communication requirements of the MTC application may vary over time based on different application-specific machine tasks and situations. For example, in the edge-assisted use-case of smart surveillance, there may be different numbers of objects with diverse behaviors (e.g., cars with different speed levels staying in the field of view of the smart device/WTRU for varying amounts of time) in the area to be surveilled at different time instances, which may lead to different amounts of data generated by the application and/or transmitted to the edge-server to run edge inference on. This type of event-based application task requirement can have a direct impact on the application round trip time latency and network bandwidth requirement (e.g., and may also be very dynamic and/or unpredictable).

As a third example challenge, a particular (e.g., same) application may have different QoS requirements based on different user behavior(s). In the example of edge-assisted smart surveillance of an area of interest, the objects of interest (e.g., cars) can have varying speeds, where some cars exhibit a cautious/safe driving user behavior while other cars exhibit an aggressive driving user behavior for instance. This user behavior may determine how long the objects of interest will stay within the field of view of the smart device performing the surveillance task. For instance, the smart device may need to transmit data captured by the sensors when an object of interest appears in the field of view to the edge server for edge inference and then receive the edge inference feedback from the server before the object of interest leaves the field of view of the sensors on the smart device. The unpredictable user behavior could thus determine the bandwidth and latency requirement of the application executing the machine type task. For example, cautious/safe driving instances may be associated with a moderate latency and bandwidth requirement, whereas aggressive driving instances may be associated with (e.g., generate) a critical bandwidth and latency requirement.

In legacy 5G NR, the application QoS is maintained through optimizations in each layer of the NW stack, some of which are controlled by the NW (e.g., MAC, PHY, etc.), while some are controlled by the WTRU (e.g., radio layer control (RLC), transport layer, application layer, etc.). The 5G compatible devices and the NW follow the 3GPP standard for identifying an application as belonging to a specific class, based on fixed use-cases given in 3GPP TS 23.501, which determine the application's fixed QoS bounds. The NW follows some pre-defined rules in each of the NW layers to maintain the fixed QoS bounds of the application in the NW. However, these metrics do not consider that the MTC applications are characterized by event-based traffic with varying QoS bounds and do not consider the impact of the performance of the entities that are not under the control of the network and/or the user behavior/environment that influence the QoS bounds of MTC. Some of the standard 3GPP procedures in the NW layers that are under NW control (e.g., MAC, PHY) and the NW layer that are under WTRU control, that impact the application QoS, are described below.

Examples of time domain resource assignment in 5G NR [3GPP TS 38.214] are described herein. In 5G NR, the network (NW) informs the WTRU about which slots/symbols the data can be transmitted/received through signaling of time-domain resources either dynamically or in semi-persistent manner. Dynamic scheduling in the uplink is done using physical downlink control channel (PDCCH) DCI. For semi-persistent scheduling, NR defines two mechanisms: one using PDCCH DCI and the other one via RRC signaling. In NR, DCI formats 0_0 and 0_1 are used to dynamically allocate time-domain resources for physical uplink shared channel (PUSCH). DCI formats 0_0 and 0_1 carry a 4-bit field named ‘time domain resource assignment’ which points to one of the 16 rows of a look-up table.

Each row in the look-up table provides the following parameters: slot offset K2, SLIV, and PUSCH mapping type to be applied on the PUSCH transmission. The slot offset K2 parameter is used to derive the slot in which PUSCH transmission occurs. The SLIV corresponds to jointly coded Start and Length Indicator Values, or individual values for the start symbol ‘S’ and the allocation length ‘L’.

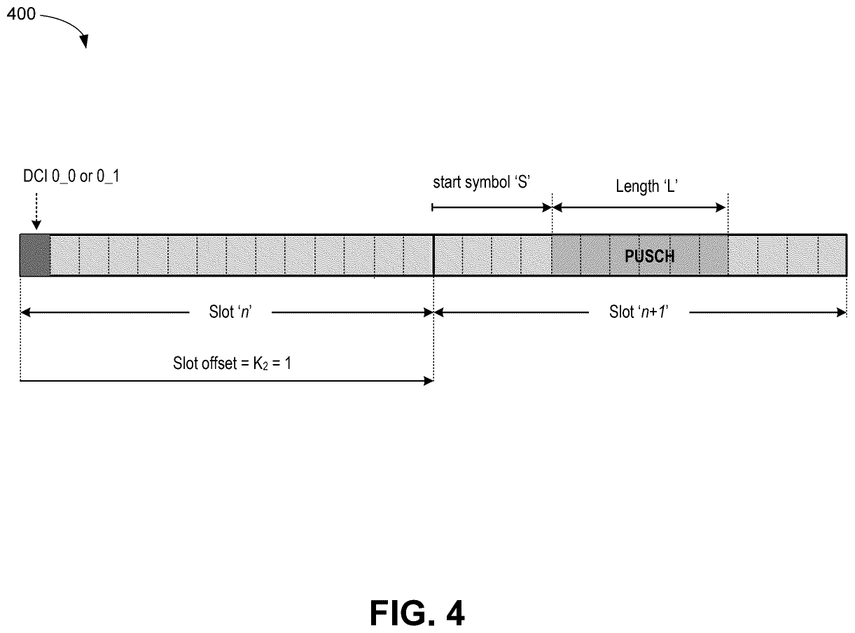

FIG. 4 illustrates an example 400 of time domain resource assignment from NW to WTRU in 5G NR. In the illustrated example, the time domain resource assignment field in DCI 0_0/0_1 is shown to indicate (e.g., based on the look-up table) K₂=1, S=4 and L=6 symbols. In this example, not all start and length values are necessarily valid because a single time-domain resource allocation should not cross the slot boundary. Moreover, the number of symbols in a slot varies with cyclic prefix which may also limit the number of allowed start and length combinations, since for normal cyclic prefix (CP) a slot contains 14 OFDM symbols, and with extended CP, 12 OFDM symbols form a slot.

There are two types of PUSCH resource allocation tables (e.g., look-up tables). The first type, “default PUSCH time domain allocation table A,” corresponds to a predefined table in TS 38.214 (e.g., Table 6.1.2.1.1-2 for normal CP and Table 6.1.2.1.1-3 for extended CP). The second type, RRC configured table pusch-TimeDomainAllocationList, may be sent in either pusch-ConfigCommon (e.g., sent via system information block 1 (SIB1) or dedicated RRC signaling) or pusch-Config (e.g., sent via dedicated RRC signaling).

The WTRU may choose an appropriate table based on several factors such as which of the above tables is configured in the WTRU, radio network temporary identifier (RNTI), search space type, etc., and the table selection criteria (e.g., specified in Table 6.1.2.1.1-1 in TS 38.214). In the PUSCH time domain resource allocation list, the value of K2 may range from 0 to 32, unlike in default table A, which allows for PUSCH transmission within the same slot where the allocation is received. When K2 field is absent, the WTRU may apply the value 1 when PUSCH SCS is 15/30 kHz, the value 2 when PUSCH SCS is 60 kHz, and the value 3 when PUSCH SCS is 120 KHz.

For uplink semi-persistent scheduling (SPS), PDCCH carrying DCI 0_0 and 0_1 may be addressed to Configured Scheduling-RNTI (CS-RNTI). The grant received using CS-RNTI may be referred to as configured grant/scheduling, which may be given by the NW to WTRU. The WTRU may store the received grant and use it according to the pre-configured timing given by the network.

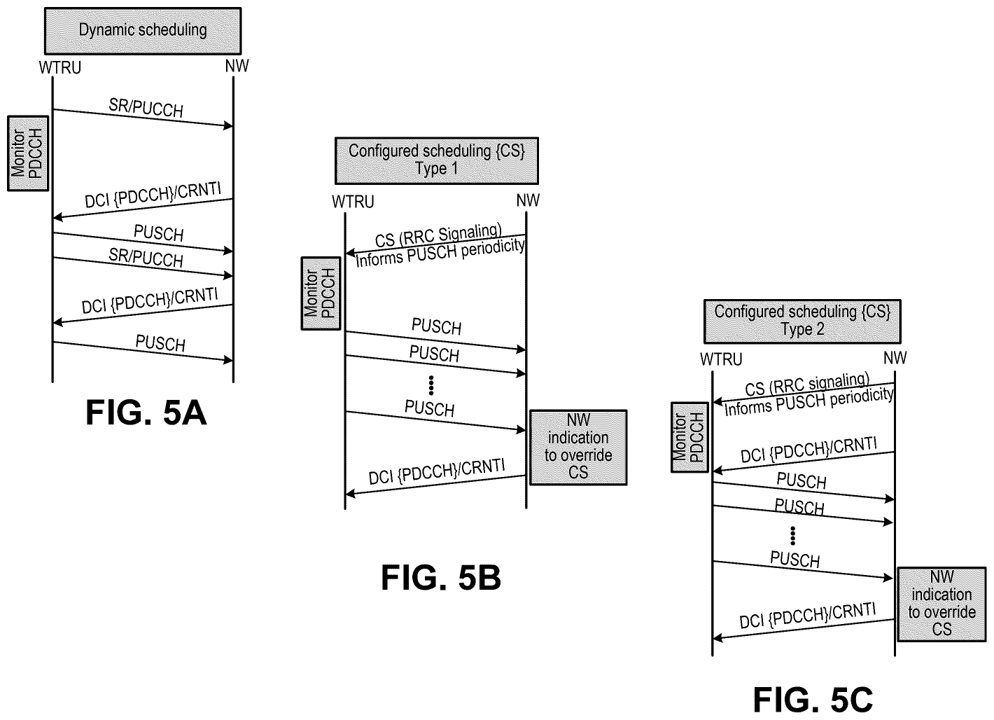

FIGS. 5A, 5B, and 5C illustrate dynamic and configured scheduling (CS) in 5G NR. Particularly, FIG. 5A illustrates an example of dynamic scheduling in 5G NR, FIG. 5B illustrates an example of CS Type 1 in 5G NR, and FIG. 5C illustrates an example of CS Type 2 in 5G NR. In configured grant Type 1, the resource allocation is done using RRC. PDCCH DCI 0_0 or 0_1 addressed to CS-RNTI may be used only for re-transmissions. For example, in this type of resource allocation, once the network configures time-domain resource using RRC, the only way to change the allocation is by re-configuring the parameters by sending another RRCReconfiguration message to the WTRU. In configured grant Type 2, the time-domain resource allocation is done using PDCCH DCI (format 0_0 or 0_1) addressed to CS-RNTI. Once configured using DCI 0_0 or 0_1, the WTRU periodically uses same time-domain resources until the configured grant is re-activated (e.g., kind of reconfiguration at MAC level).

Examples of frequency domain resource assignment in 5G NR [3GPP TS 38.214] are described herein.

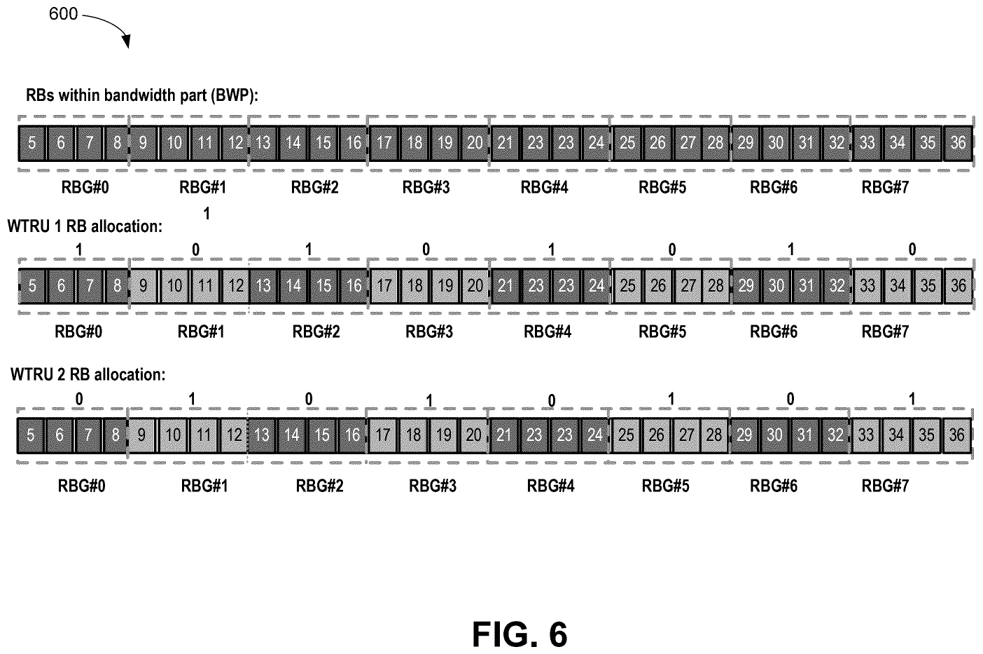

FIG. 6 illustrates an example 600 of frequency domain resource assignment for WTRUs in 5G NR. In frequency domain resource allocation, the NW informs the WTRU about the frequency resources to be used for the transmission of PUSCH using DCI Formats 0_0, 0_1 or 0_2. Within these DCI Formats, the field ‘Frequency domain resource assignment’ carries the required resource allocation information, which informs the WTRU about resource blocks (RBs) and the corresponding bandwidth part (BWP) on which the intended data is to be transmitted/received. Using the allocated frequency resources, the WTRU transmits/receives the data on PUSCH/physical downlink shared channel (PDSCH). NR supports three types of uplink resource allocation schemes: type 0, type 1, and type 2. The uplink resource allocation scheme type 0 may be supported for PUSCH only when transform precoding is disabled. Uplink resource allocation scheme type 1 and type 2 are supported for PUSCH for both cases when transform precoding is enabled or disabled. The network informs the WTRU about which resource allocation scheme is to be used via RRC signaling. PUSCH-Config information element (IE) may be used for dynamic resource allocations and ConfiguredGrantConfig IE may be used for configured grant (e.g., semi-persistent) resource allocations. Taking example of Type 0 uplink resource allocation, the field ‘Frequency domain resource assignment’ (bitmap) within DCI 0_1/0_2 is used to indicate which Resource Block Groups (RBGs) are allocated to the WTRU. For example, an RBG may be allocated to the WTRU if the corresponding bit value in the bitmap is 1; whereas the RBG may not be allocated to the UE if the bit value is 0. Consider an example with two WTRUs in configuration type 2, where WTRU1 resource allocation bitmap=10101010, WTRU2 bitmap=01010101, start RB of the BWP is 5, and BWP size is 32 RBs. FIG. 6 illustrates which RBs are allocated to WTRU1 and WTRU2 in this example.

Examples of PHY layer latency in 5G NR [3GPP TS 38.214] are described herein. In an example, the NW divides the (e.g., entire, available, etc.) operational bandwidth into time slots where some slots are for downlink, some are for uplink transmissions, while some are flexible slots used for downlink or uplink. This approach of resource allocation is called Time-Division-Duplexing (TDD).

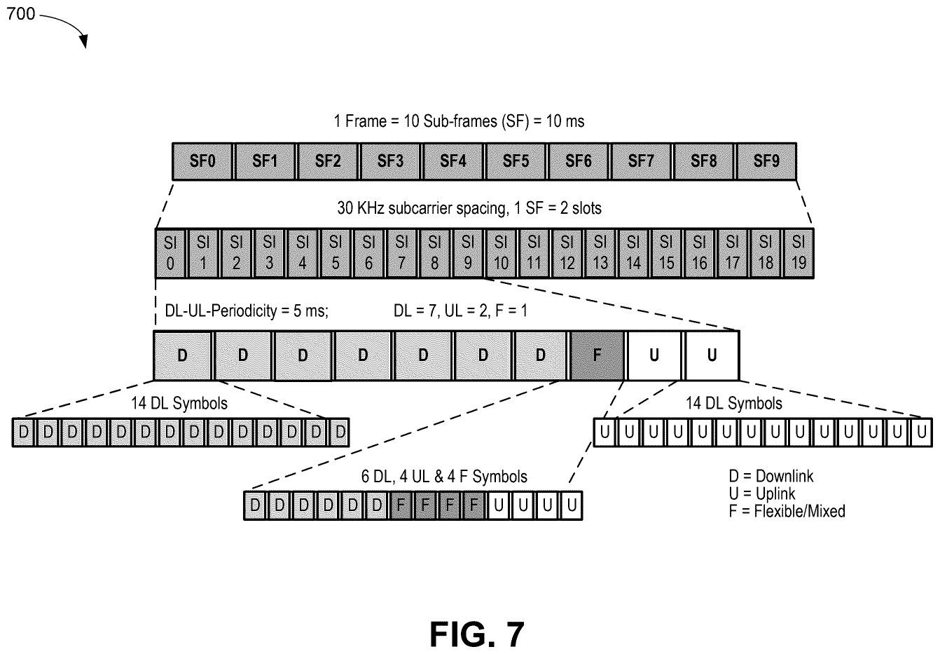

FIG. 7 illustrates an example of a 5G NR PHY frame structure 700 with 30 kHz sub-carrier spacing. For example, a frame in 5G NR may be 10 ms long, which is broken down into 10 subframes. Depending on the numerology, the number of slots in a subframe varies. For instance, as shown, a subframe with 30 KHz subcarrier spacing (SCS) may have two slots. In TDD, DL-UL-periodicity determines the time for which there can be a consecutive set of downlink and uplink slots. Each slot is further broken down into symbols.

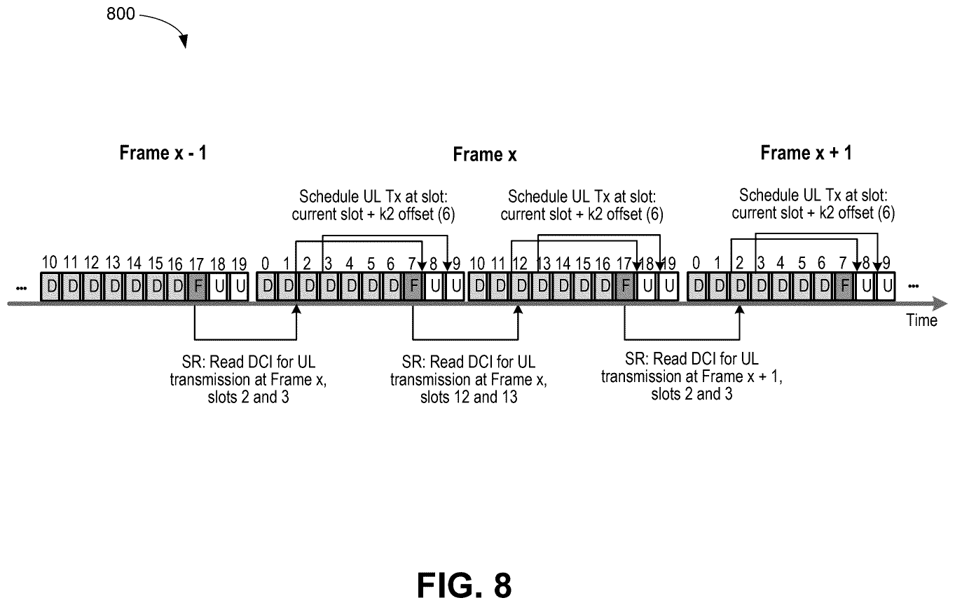

FIG. 8 illustrates an example 800 of an uplink transmission process in 5G NR PHY TDD configuration with 30 KHz SCS. The uplink transmission methodology in TDD is described in more detail with reference to the example of FIG. 8. First, in a flexible (F) slot, the WTRU sends a scheduling request (SR) to the NW indicating that it has some data to send. The NW, in the next DL DCI slot (e.g., could be in the same frame or the next frame) schedules the next UL slot for the WTRU to send the data finally.

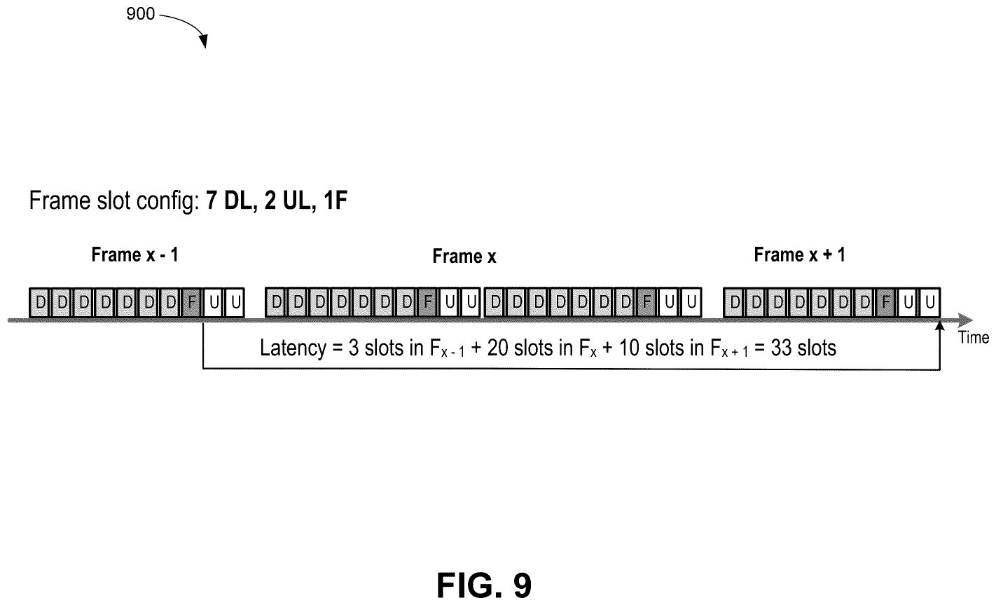

FIG. 9 illustrates an example 900 of 5G-NR PHY layer latency in TDD with 30 KHz SCS and a frame configuration that includes 7DL, 2UL, and 1F. For example, FIGS. 8 and 9 may quantify the PHY layer latency required to upload data from a WTRU to NW. If 6 UL slots are needed to finish an uplink intensive task, then based on a configuration that allows 7 DL (‘D’) slots, 2 UL (‘U’) slots and 1 flexible (‘F’) slot, it takes 33 slots to finish the UL task. The PHY latency for UL may be calculated as the time difference between when the last UL data was sent in a particular slot in a frame and the time at which the first scheduling request (SR) for the UL data was sent to the NW. Thus, in the illustrated example, the PHY latency may correspond to the time equivalent of 33 slots.

Examples of MAC layer latency in 5G NR [3GPP TS 38.321] are described herein. For example, the MAC scheduler at each base station (gNB) may decide the WTRU-wise physical resource block (PRB) allocation for every slot. In FDD, both PDSCH and PUSCH allocations are output per slot, while in TDD, the appropriate (PDSCH or PUSCH) allocation is output every slot (e.g., DL or UL).

The scheduler may take one or more inputs for each gNB and attached WTRU. A first example input is the number of MIMO layers. A second example input may be DL-PDSCH signal to interference noise ratio (SINR) at each layer. A third example input may be CQI at each layer. A fourth example input may be modulation and coding scheme (MCS) at each layer. A fifth example input may be UL-PUSCH SINR at each layer. A sixth example input may be a channel quality indicator (CQI) at each layer. A sixth example input may be MCS at each layer. A seventh example input may be DL Buffer status (e.g., Buffer Fill, Type of traffic such as guaranteed bit rate (GBR) or Non-GBR). An eighth example input may be UL Buffer status (e.g., Buffer Fill, Type of traffic (GBR/Non-GBR)). A ninth example input may be DL hybrid automatic repeat request (HARQ) context (e.g., redundancy version (RV), HARQ identifier (HARQ-ID), new data indicator (NDI). A tenth example input may be UL HARQ context (e.g., RV, HARQ-ID, NDI). The scheduler may also use the number of PRBs available in the gNB. For example, re-transmissions may be prioritized over first transmissions.

Various baseline MAC scheduling algorithms are available in 3GPP. A first example algorithm (Round Robin) involves dividing the available PRBs among active flows, i.e., those logical channels that have a non-empty RLC queue. The MCS for each user is calculated according to the received CQIs. A second example algorithm (Proportional Fair (PF)) involves scheduling a (e.g., active) user when its instantaneous channel quality is high relative to its own average channel condition over time. The PF scheme is based on the current data rate for each user and an exponentially weighted moving average (EWMA) data rate over an immediately prior predetermined interval for each user. In comparison with the round-robin (RR) scheduler (e.g., in which WTRUs are cyclically scheduled irrespective of the channel condition), the PF scheduler maximizes the system throughput while maintaining long-term fairness in the allocation of resources between users. A third example algorithm (Max Throughput) involves allocating PRBs to the active flow(s) to maximize the achievable rate. In other words, it selects the user that sees the highest CQI. Thus, generally, the output of a scheduler may include WTRU-wise allocation in the UL and DL (e.g., at every slot).

Examples of RLC layer latency in 5G NR [3GPP TS 38.214, TS 38.322] are described herein. In an example, packets may flow through the 5G stack until the RLC buffer, and may start accumulating there, as the wireless link is typically the slowest link in the data path. Packets may wait at the RLC sublayer until the MAC scheduler pulls a specific number of bytes. While every WTRU may be provided with at least one data radio bearer (DRB), up to 30 DRBs per WTRU can coexist, and therefore, 30 RLC buffers. Parallel queues may be formed, and thus, the MAC scheduler may have to map the available resources to the RLC buffers according to the scheduler policy (e.g., round-robin). In an example, the RLC buffer may be a first in first out (FIFO) queue, such that packets within a DRB are treated equally and, therefore the MAC scheduler can only access the most recently inserted packets after it has pulled the older ones. This introduces a precedence relation for the packets that belong to the same queue (i.e., packets from the same queue can only be egressed following the arrival order).

Furthermore, in some examples, the radio resource allocation performed by the MAC scheduler may not map bytes directly to the RLC buffers, but rather the MAC scheduler assigns Resource Blocks (RBs). RBs may be grouped into Resource Block Groups (RBGs) according to the cell configuration. For example, in a 5 MHz bandwidth cell with Type 0 and Configuration 1, the minimum number of RBs to distribute is 2, except for the last RB. Thus, an RBG may be the smallest unit that can be assigned to a WTRU. Moreover, to assure an error rate below 10%, the WTRU may deliver a channel quality estimation through the Channel Quality Indicator (CQI) in uplink. The CQI is a scalar and its value is translated into a Modulation and Coding Scheme (MCS). The MCS defines the modulation to use (e.g., binary phase shift keying (BPSK), quadrature phase shift keying (QPSK), 16 quadrature amplitude modulation (QAM), 64 QAM or 256 QAM that transmit 1, 2, 4, 6 or 8 bits per symbol respectively, etc.) and coding rate. Thus, channel capacity may depend on (e.g., be determined by) the radio conditions (i.e., under good radio conditions, larger amount of information can be transmitted). Furthermore, 3GPP defines three different modes in which a RLC entity can be instantiated: Transmission Mode (TM), Unacknowledged Mode (UM). and Acknowledged Mode (AM). Through a TM entity, only control information can be forwarded, while data information can flow by either a UM or AM entity. Both UM and AM share the ability to segment a packet if the transport block size (TBS) notified by the MAC does not fit within the size of the packets waiting.

According to 3GPP, packets at the RLC sublayer may be segmented if the RLC service data unit (SDU) size is larger than the bytes requested by the MAC sublayer. Once packets are segmented and an RLC header is added, they are transmitted to the RLC of the receiver, where after removing the RLC header, they wait for a SDU reassembly before submitting them to the next sublayer (i.e., WTRU packet data convergence protocol (PDCP) in the downlink procedure). Therefore, information may not be forwarded until a complete reassembly occurs, which in the best case will occur in the next transmission time interval (TTI). Thus, this segmentation/reassembly procedure guarantees a full frequency spectrum utilization in cases where the next packet size exceeds the TBS. For example, in a static scenario with an LTE base station with a 5 MHz bandwidth, under the best channel conditions (e.g., 28 MCS), approximately 2289 bytes can be transmitted every TTI. However, bulky flows in an IP network may use the maximum allowable packets size (e.g., 1500 bytes in Ethernet) to minimize the overhead of the protocol and maximize the transmitted information ratio. This example shows that even ignoring the capacity of the dynamic radio link channel (i.e., assuming a static TBS of 2289 bytes), a myriad of fragmented packets at the RLC sublayer may be generated as the TBS notified by the MAC could rarely coincide with the size of the packet, and consequently, the delay is increased.

Thus, a non-exhaustive list of example principal constraints associated with the RLC segmentation/reassembly procedure are summarized as follows. First, the RLC buffers are FIFO queues, and thus the packets cannot be pulled arbitrarily. Second, resource allocation is performed through RBG, rather than bytes. Third, MCS determines the channel capacity, which may dynamically change according to the radio link conditions.

For emerging machine-type communications (MTC), such as in Connected Autonomous Vehicles (CAV), etc., to maintain the necessary machine-task Quality of Service (QoS), the core tasks may have stringent low-latency deadlines. These deadlines may be dynamic for MTC because MTC traffic may be primarily event driven with dynamic priorities for packets belonging to the same type of application. For example, some (e.g., or many) applications may not be able to run compute intensive AI/ML tasks like object-detection, depth estimation, or path planning on resource-constrained devices. In such cases, the MTC application may offload the AI/ML inference tasks to edge servers. However, the stringent QoS requirements of these applications may stress the uplink bandwidth of the wireless access networks. 5G-NR allows the flexibility of choosing an optimal configuration from an available list of different possible configurations across the different NW layers, to maintain the user QoS that conforms to one of the QoS classes in the 3GPP 5QI Table 5.7.4-1 in TS 23.501. In the current 5G NR standard, the NW relies on WTRU reports of estimated channel conditions and the current WTRU traffic in buffer to decide the optimal configurations for an application running in a WTRU. In scenarios where the channel conditions for the WTRU degrade, the NW may identify this degradation from the following (e.g., subsequent) WTRU report on channel estimates. The NW may then decide whether to update the NW configuration(s) and notify the WTRU accordingly. This reactive mechanism can be slow to converge to an optimal NW configuration for the WTRU in dynamic channels with high variance in channel metrics like SINR, reference signal received power (RSRP), relative signal strength indicator (RSSI), etc., which increases the probability of overshooting QoS thresholds for WTRUs associated with MTC. Additionally, human-type-communications (HTC) requirements differ fundamentally from MTC requirements, since MTC traffic may be primarily event driven with dynamic priorities for packets belonging to the same type of application. Legacy 5G networks generally determine a static QoS for an application based on the application classification (e.g., in TS 23.501) and determine the network parameters to meet these QoS thresholds. As such, these fixed use case centric optimizations may not be suitable to meet the dynamic QoS requirements associated with emerging MTC applications. This leads to inefficient network/spectrum resource utilization and increases the probability of overshooting the QoS thresholds for MTC applications. Also, given the large number of available parameters in the NW and application layers that may need to be customized for diverse and custom QoS requirements of MTC, hand engineering specific configurations of such parameters for each real-world scenario may not be a scalable and efficient approach in some scenarios.

The present disclosure provides solutions that address the various drawbacks described above, for example, by enabling next-generation cellular networks to understand the context of WTRU machine-type task performance over the network according to application requirements and characteristics, WTRU characteristics, wireless channel conditions, and/or NW configuration/requirements. Thus, example systems and methods described herein may enable the NW to learn the optimal configuration across the application and/or the network layers as well as meet the dynamic, event-based, custom QoS requirement(s) of MTC traffic. Furthermore, example systems and methods described herein may enable the network to be aware of changing application demands and/or quickly converge to optimal NW and application configurations for the custom and dynamic QoS requirements of such emerging applications. For the sake of example, a MTC use case that involves license-plate identification for intelligent surveillance is described in greater detail below.

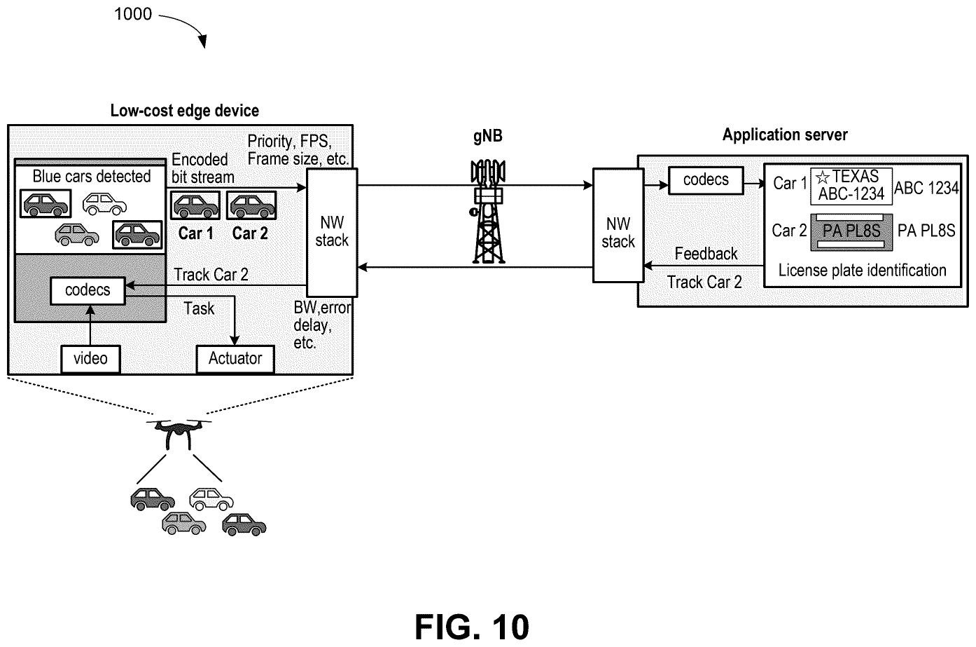

FIG. 10 is a system diagram 1000 illustrating an example use case of edge-based object classification and car license-plate identification for intelligent surveillance. In this example, a WTRU (e.g., low-cost edge-device) with limited computation power and/or limited battery (e.g., an unmanned aerial/ground vehicle) monitors a section of a highway through video streams captured from the on-board camera. The device may use lightweight AI/ML models on the device to perform part of a machine-task such as object detection whenever a vehicle is detected in a video frame. The device then transmits the compressed data of the detected object to the remote server for edge-assisted inference of license plate detection. The edge-server application may generate feedback for the device (e.g., transmitted over the network), such as capturing future video frames at specific camera resolutions and/or compression techniques which can generate better confidence levels for inferencing the object class (e.g., car, motorcycle, bus, truck, etc.), for example. The device performs the necessary tasks as directed by the edge server application and transmits the specific video frames (e.g., in the requested format) to the edge-server application. The edge-server application then generates feedback to the device informing the device to take follow on (e.g., or follow-up) actions such as tracking or following the car based on the inference results of license plate identification (e.g., positive identification of a car that needs tracking, etc.).

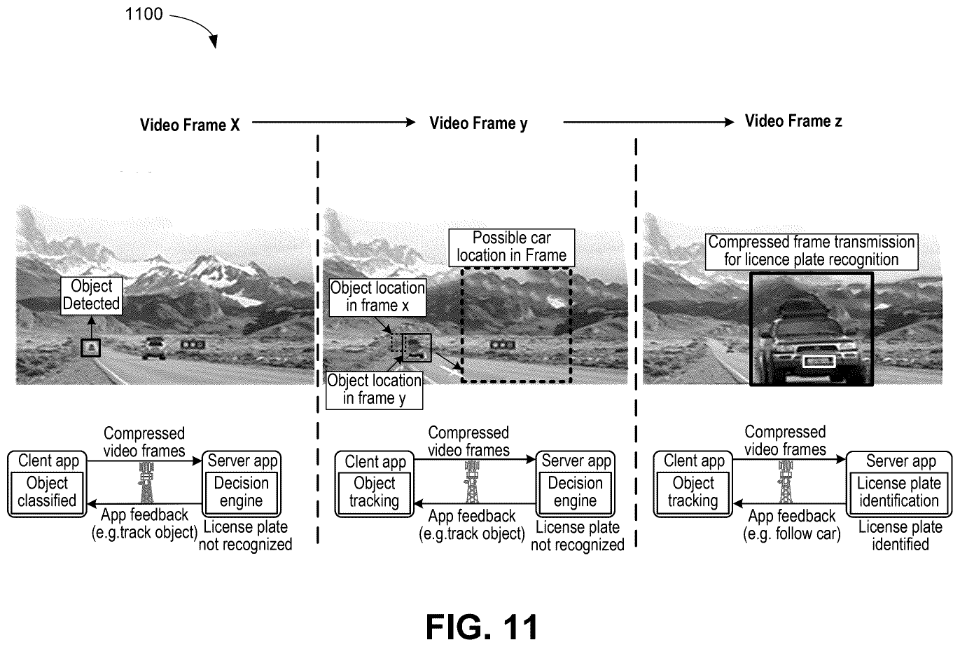

FIG. 11 illustrates an example scenario 1100 depicting the priority of (e.g., capture, transmission, etc.) a video frame based on the machine-type task (e.g., object detection versus license plate identification). In this example, the machine-type application QoS in terms of round-trip time estimation for autonomous tracking of a car based on edge-server based license place identification may depend on the speed of the vehicle, the atmospheric conditions (e.g., foggy, sunny, rainy, etc.), the field of view of the camera, etc.

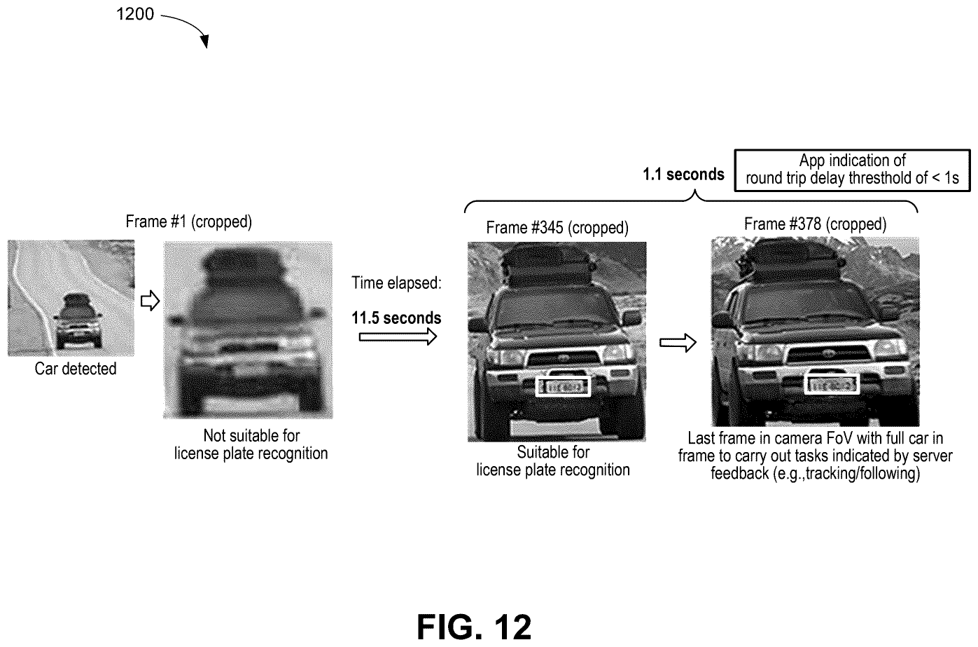

FIG. 12 illustrates an example scenario 1200 for estimating a threshold of round-trip time of video frame generation to inference feedback reception (e.g., at a WTRU) from a remote server for a machine-type task such as intelligent surveillance. In this example scenario, at a rural location, the camera on the device is capturing video frames in 1080-pixel resolution at 30 frames per second. As a car is detected in Frame #1, the frame is compressed and transmitted via the network to the edge server application for inferencing tasks of license plate identification. The edge server application determines that the frame is not suitable for license plate detection due to factors which may include but are not limited to distance of the vehicle (e.g., car, detected object, etc.) from the device, frame compression technique, etc. The edge server application informs the edge device to continue transmitting frames where the object is detected for edge-based tracking and future position estimation of the object in a future frame. The edge server subsequently informs the edge device through the network to capture a future frame according to a specific compression technique where the object is projected to be at a suitable location in the frame with suitable features for carrying out the machine-task of object classification and license plate identification. This arrival/capture time of the projected future frame (e.g., frame #345 in the illustrated example), and the duration of time the object stays within the camera field of view or in the frame (e.g., frame #345 to frame #378 in the illustrated example) which is of high importance, may be determined based on external factors such as vehicle speed, camera field of view, etc. Furthermore, these factors may contribute to the determination of a suitable application round trip time from object classification (e.g., type car) at frame #345, license plate identification (e.g., positive identification) and finally feedback to the device (e.g., instructions to follow car) by frame #378. In this example, the client application in the edge device needs to get the inference feedback before frame #378. If the inference decision reaches the edge device after this time frame, then the feedback will be stale since the vehicle has gone past the camera field of view and the device cannot perform the task required in the feedback (e.g., to follow the car). The WTRU and/or the NW may calculate this time duration from frame #345 to frame #378 (e.g., total of 33 frames) based on the camera frame rate (e.g., frames per second (FPS)). For example, at 30 FPS, the round-trip time (e.g., QoS requirement) may be determined (e.g., or set, or needs) to be less than 1 second.

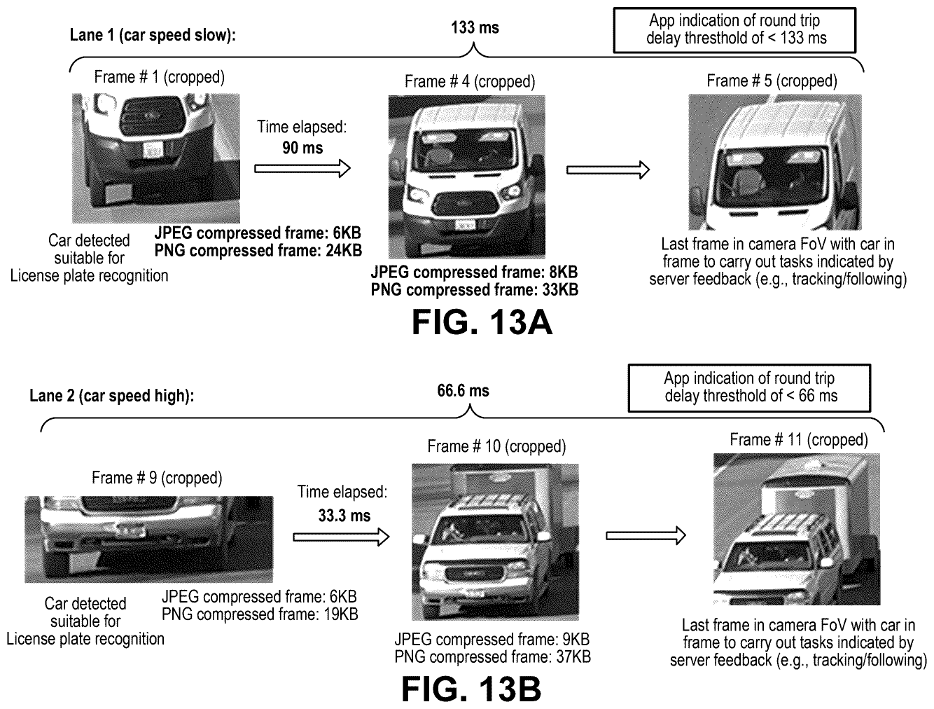

FIGS. 13A and 13B illustrate example scenarios showcasing the dynamic nature of the QoS (e.g., round trip time threshold) of a machine-type application, for example, which may vary depending on WTRU environment characteristics. For example, the dynamic QoS requirement of a specific MTC application (e.g., vehicle detection and license plate identification) may depend on WTRU environment characteristics such as speed and/or direction of the detected objects (e.g., car in Frames #1, 4, 5 vs. car in Frames #9, 10, 11).

In the example scenarios of FIGS. 13A and 13B, the same edge-server assisted machine-type task of object classification and license plate identification is carried out by the WTRU (e.g., low-cost edge-device) but at a different location. In this example, the QoS for the round trip time associated with the vehicles of FIGS. 13A-13B is different than that of the vehicle of FIG. 12, even though the application is relying on video data to perform the same task (e.g., for the same application type as in the previous example of FIG. 12). This discrepancy in QoS requirements is because the edge device/WTRU environment has changed to a two-lane highway at a busy area where cars are moving at greater speeds compared to the previous example. Also, cars are moving at different speeds on different lanes of the highway. Thus, the amount of time the cars spend in the camera field of view is much less compared to the previous example. The angle at which the camera on the device is ‘looking’ at the highway also influences this time limit. The cars in lane #2 (FIG. 13B), for example, may remain in the camera field of view for only a couple of frames compared to the cars in lane #1 (FIG. 13A) where the cars remain in the camera field of view for more (e.g., ˜4-5) frames. At 30 FPS, this translates to a machine-type task round trip time of <133 ms for lane #1 (FIG. 13A) and <66 ms for lane #2 (FIG. 13B). This shows that, for MTC applications, even if the device type and the application type remain the same, the WTRU environment and/or the behavior of objects in the WTRU environment determine the machine-type task and/or application QoS thresholds.

Thus, QoS thresholds associated with MTC applications may be dynamic and/or event-based (e.g., perform a task only when objects are detected), which could result in MTC applications being remarkably different from traditional human-type applications. In some scenarios, data compression techniques can also affect AI/ML inference performance (e.g., confidence levels of object detection on the compressed data) of edge-assisted MTC applications. Based on the upper and lower bounds of the confidence thresholds, for example, the application can choose a specific compression technique that meets the threshold bounds. This has a direct impact on the application data rate, which translates to a custom QoS demand over the network, in edge-assisted inference scenarios. Current 5G networks and machine-type applications do not exchange the network capacity and machine-task performance thresholds and rely on the existing static QoS rules (e.g., in TS 23.501) to provide a service that can be sub-optimal. The present disclosure includes example systems and methods that enable an AI/ML enabled 5G network to account for application machine-task performance bounds and/or available compression techniques to enable context-aware optimization across the network and application layers. For example, in worst-case scenarios of high user density and low spectrum capacity, the network can request the application to use a specific compression technique that meets the lower bound of the machine-task inference confidence threshold at the edge server with relatively lower utilization of network resources in transporting the compressed data from the WTRU to the edge server.

Example drawbacks of legacy 5G QoS rules in serving emerging machine-type applications with dynamic QoS thresholds are described herein. For example, many (e.g., or most) cellular deployments are configured to meet demands from human-type communications which is characterized by predictable demand in network traffic and higher demand in downlink compared to uplink. The current network provides fixed rules for mapping user data requirements to certain QoS rules. Therefore, the network is optimized for fixed use cases whose requirements are bounded. Although techniques for over-optimizing network parameters to reduce application latency as much as possible and/or increasing the application goodput as much as possible may serve the purpose of meeting the demands of traditional human type applications, these techniques may not necessarily achieve similar results for machine type applications. For example, if the network is optimized to provide an application round trip time of less than 60 ms to other users of the same application type or if the edge device application round-trip time (RTT) QoS varies between 30 ms and 60 ms depending on the speed of the cars on the road, then the legacy network may choose to provide the lowest RTT latency to (e.g., all users of) the machine-type application. Referring to the above examples of edge-assisted license plate identification (e.g., FIGS. 13A and 13B), if the application QoS threshold of round-trip time is 60 ms, then providing a lower round trip time latency (e.g., 30 ms) will not change the machine task performance of the target edge device application. The edge device will still be able to execute the machine-type task of tracking the car irrespective of whether the edge server feedback reached the edge device at a time less than 60 ms. But in providing a round-trip time latency that is less than what is required, the network needlessly allocates more resources which could have been used for serving other users, and henceforth could have improved the overall network capacity and spectrum utilization.

Legacy 5G networks may classify application types by referring to the 3GPP Table 5.7.4-1 in TS 23.501 and may thus allocate network resources to meet the pre-determined QoS thresholds belonging to the application type (e.g., that are given in the table). The legacy 5G network strives to meet these thresholds for an application which it can classify as belonging to one of the entries in this table. However, such fixed use case centric optimizations leads to fixed QoS categorization based on use case, lacks predictive intelligence in legacy optimizations, lacks context or state awareness in NW, and lacks finer granularity in QoS levels, among other drawbacks. As shown in the above examples and figures, the task requirement for a specific machine-type application may vary at different times and may not be mapped directly to one of the 5G QoS Identifier (5QI) rows, which may lead to inefficient resource allocation, reduced task precision for machine type-applications, scalability issues across emerging and dynamic applications, and/or inefficient spectrum allocation/reduced network capacity, etc.

The present disclosure provides example systems and methods that enable next-generation cellular networks to consider (e.g., or become aware of) the context of machine-type task performance by accounting for (e.g., or through a more complete understanding of) application, network, and/or device characteristics and requirements, as well as wireless channel conditions, so that the custom and dynamic QoS requirements for event-driven machine-type tasks can be satisfied. Through the awareness of this context, the next generation cellular networks can optimize the application and network layer parameters based on the context or the situation of the devices connected to them. The “context” can include but are not limited to the application configuration, application current QoS demand, UE characteristics such as location, mobility, etc., WTRU environment such as number of objects, mobility of objects, atmospheric conditions, etc., NW configuration, wireless channel condition, etc. This context can enable the networks to prioritize UEs, applications, data flows and individual data packets based on the event-driven traffic characteristics, manage network resources, configure application parameters and adapt based on the custom QoS needs of these machine-type tasks.

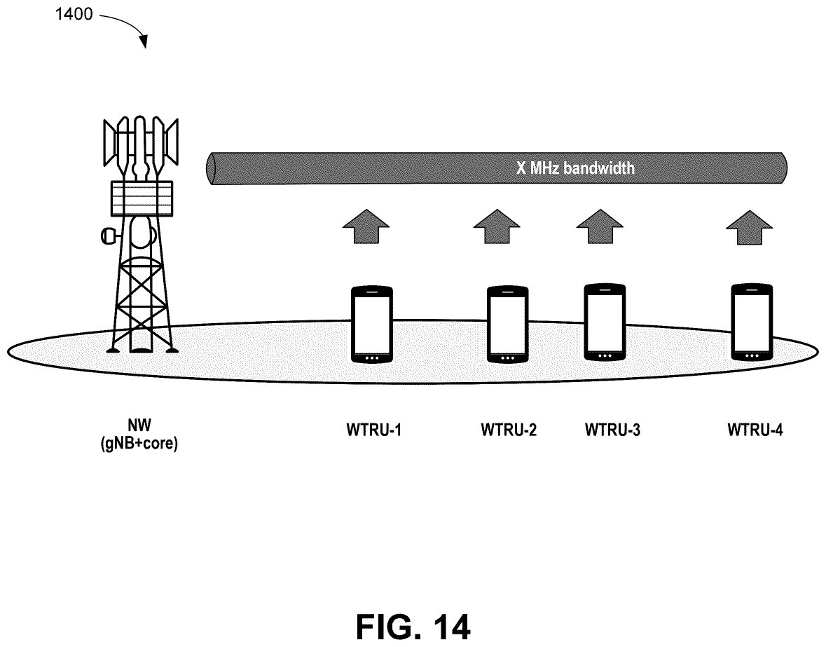

FIG. 14 is a system diagram 1400 of an example cellular network environment that includes multiple mobile WTRUs running machine type applications and connected to a NW (e.g., gNB and Core Network). In this example, multiple WTRUs are performing edge or remote server assisted machine-type tasks and are connected to the NW. The WTRUs generate application data such as video frames at different rates and sizes depending on the type of machine-type task and installed camera hardware. The WTRU(s) transmit this application data, which is delivered by the network to the remote or edge server. The remote or edge server then proceeds with executing machine task inference. The network may then deliver the inference results from the remote server to the WTRUs, e.g., in a timely manner such that the WTRUs can take follow on action for the machine-type task. To generate the context about these machine-type tasks and their performance, the WTRUs transmit context information related to the machine-type task requirement(s), WTRU environment, WTRU characteristics, application characteristics and requirement(s), and/or channel condition information to the NW. The NW may enrich this context information, for example, through the addition of information not readily available to the WTRUs (e.g., NW configuration). This (e.g., completed, updated, etc.) context information may indicate the context or state of the machine-type task.

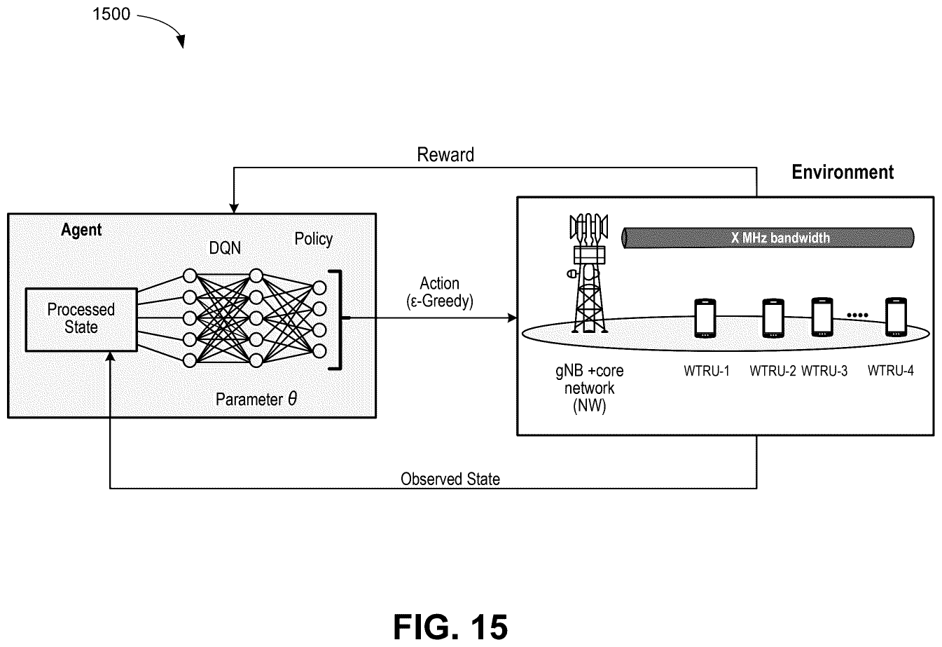

FIG. 15 illustrates an example 1500 of a DQN reinforcement learning agent architecture for context-aware optimization in the WTRU and the cellular network across the NW and application layers. In this example, the agent is interacting with the environment based on the policy, the observed state, network action, and/or collected reward. Thus, the observed state may be used as an input to AI/ML agent(s) (e.g., a DQN based reinforcement learning agent), such as the agent shown in FIG. 15, that learns the optimal configuration across the NW and application layers based on the AI/ML agent policy, the observed state, the action of configuring the NW and application layer parameters, and/or the collected reward, based on the achieved latency and how far this achieved latency falls from the required latency threshold (which can be dynamic based on multiple factors in line with the discussion above). The optimal NW and application layer parameters for the custom QoS requirement, achieved through this context-aware optimization, may be implemented by the WTRU and/or NW. Assuming the AI/ML agent(s) reside on the NW side, for example, the NW may transmit context-aware optimized parameters for the WTRU (e.g., upper NW layer parameters such as RLC, transport layer, etc., as well as application layer parameters such as data size and data rate) to the WTRU for WTRU side implementation before actual transmission of the machine-type task data. This process may continue for the time the machine-type applications stay active and/or demand custom QoS from the NW.

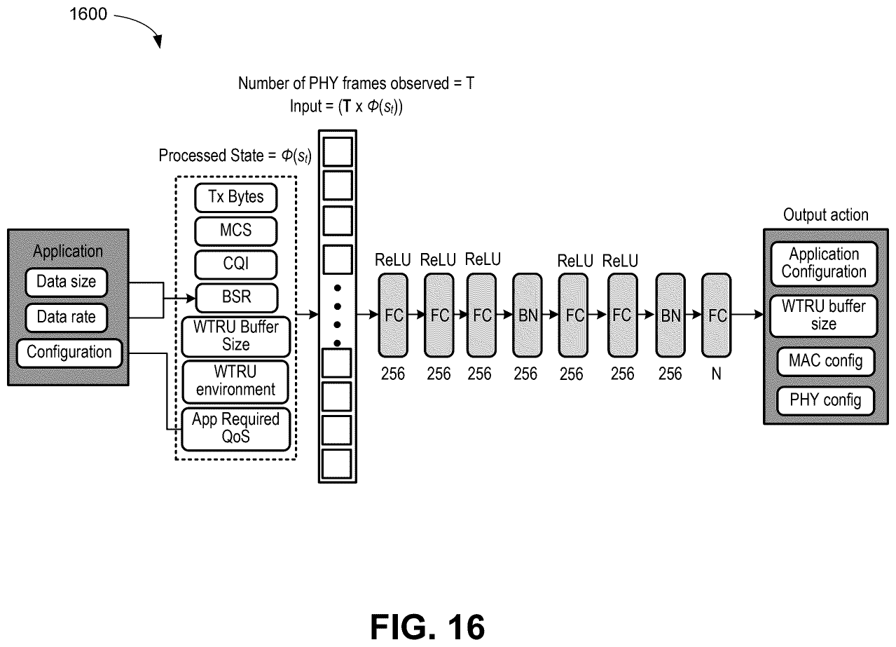

FIG. 16 illustrates an example deep reinforcement learning (DRL) network architecture 1600 for context-aware optimization in the WTRU and the cellular network across the NW and architecture layers. In this example, the WTRU application characteristics and requirement as well as the wireless channel estimates and the NW configuration together represent the observed state which is used as input to the reinforcement learning network. The output action of this network includes the Application configuration, the WTRU buffer size, and/or the NW MAC and PHY configuration. The output action may be generated based on the achieved reward and/or the reinforcement learning policy. Thus, the DRL that enables this context-aware optimization uses the input data (e.g., context information) to generate the output action (e.g., the context-aware optimized NW and application layer parameters) that will meet the custom QoS demand of the machine-type application.

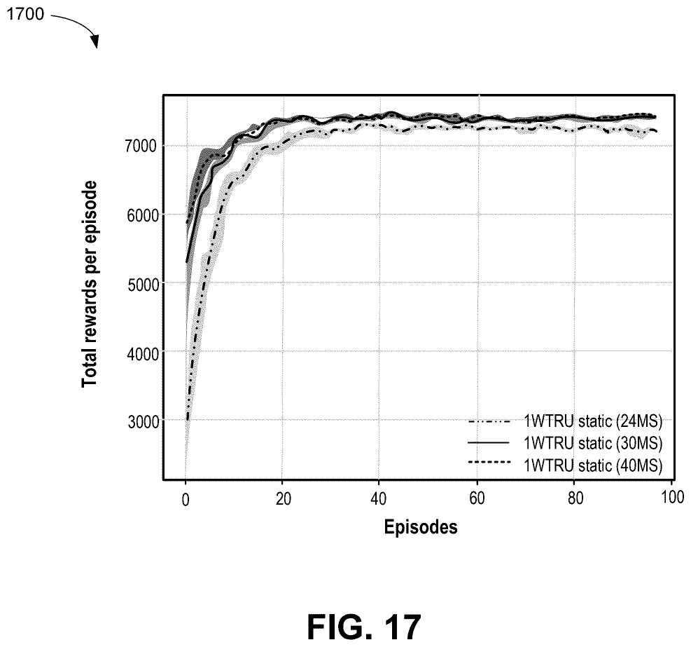

FIG. 17 is a graph 1700 illustrating an example performance of the proposed DRL agent (e.g., in terms of total rewards per episode during training for context-aware optimization for a single mobile user in different latency requirements). The solid lines represent smoothed averages (e.g., window size of 2 episodes), and the shaded areas represent standard deviations. In this example, epsilon greedy is used as the acting policy while the greedy policy is used as the updating policy. FIG. 17 shows the achieved rewards for the different WTRUs (e.g., the higher the better) by the deep reinforcement learning (DRL) agent(s) in providing the NW and application layer parameters that met the custom QoS requirement for each WTRU.

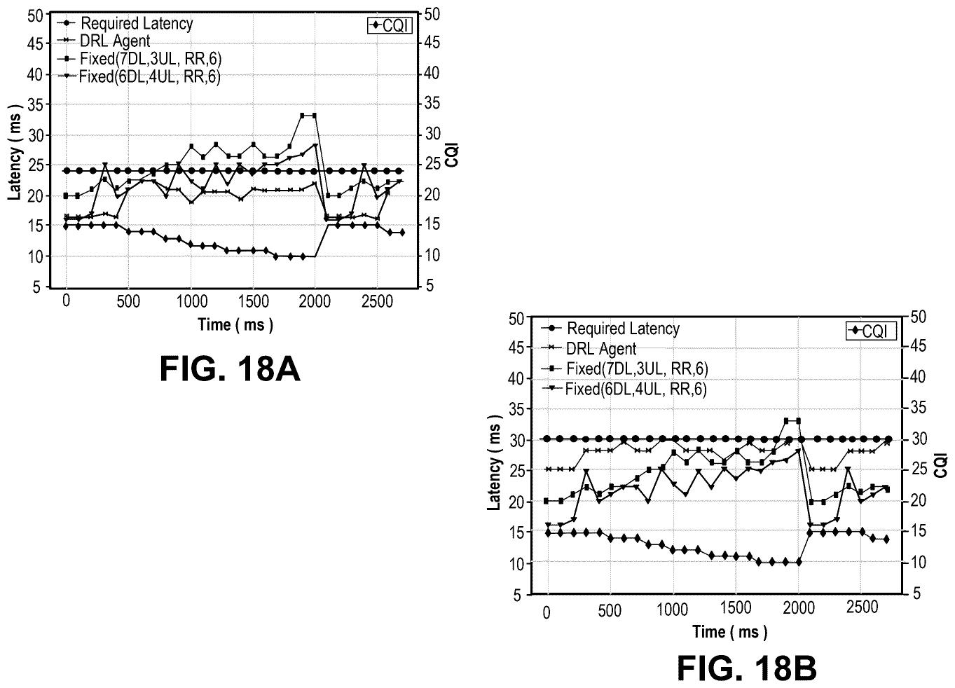

FIGS. 18A and 18B illustrate examples of the performance of the proposed context-aware optimization (e.g., DRL agent) compared to legacy 5G NW optimization in terms of latency for emerging machine type applications in a mobile environment. In the illustrated examples, performance of the DRL agent(s) in terms of the achieved latency for the WTRUs, compared to some of the legacy 5G network configurations (fixed cases), and how far the achieved latency was from the required latency, in dynamic channel conditions, given by the channel quality indicator (CQI). The DRL agent generated custom configurations in the NW and application layers for each WTRU, resulted in the WTRUs achieving the dynamic latency target (required latency of 25 ms in FIG. 18A and 30 ms in FIG. 18B), as demanded by the application in diverse channel conditions (CQI levels), compared to some of the legacy NW configurations (fixed scenarios in FIGS. 18A, 18B), which either overshoot the required latency threshold (FIG. 18A) or overoptimize the parameters to generate a latency which is well below the required latency threshold (FIG. 18B) thus wasting valuable resources. Whereas, as shown, the achieved latency of the proposed solution (DRL agent) stays close to the required latency, does not overshoot the required latency threshold, and does not over optimize the NW and application parameters, thus conserving valuable resources.

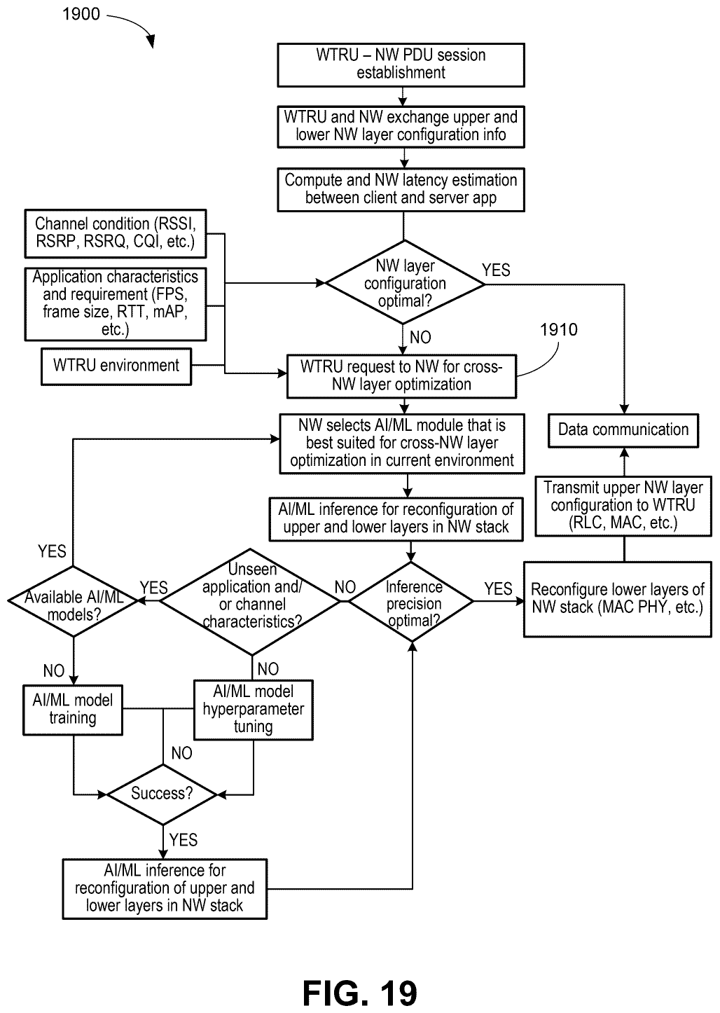

FIG. 19 is a flowchart illustrating an example assisted context-aware optimization process 1900 executed in the cellular network across the NW and application layers to accommodate dynamic and custom machine type application QoS requirements. The flowchart depicted in FIG. 19 shows the various steps for context-aware optimization in next generation cellular networks and the interaction between the different WTRU and NW functions to execute and implement the process 1900, in accordance with the present disclosure.

Example methods for WTRU assisted context-aware optimization in next-generation cellular networks are described herein. The proposed approach described herein includes a method that may enable next generation cellular networks to be aware of the context of WTRU machine-type task performance so that the NW can intelligently meet custom and dynamic event-based QoS requirements with WTRU assistance. Thus, the present methods and systems may improve machine-type task performance, NW efficiency, and/or reduce signalling overhead.

The WTRU executing edge-assisted machine-type task requests (operation 1910) context-aware optimization from the serving network to meet the dynamic and event-related application and machine task QoS. The WTRU provides WTRU-side context related to the task, to the network. The network generates the network-side context related to the execution and performance of the machine-type task. The network uses this complete contextual information as input to the trained AI/ML agent(s) for generating the context-aware optimized parameters for both the network and the application layers, and for achieving (e.g., or meeting) the requested dynamic and/or event-related application and machine task QoS.

The WTRU client machine-type application may set up a connection with the remote server machine-type application and initiate data communication for executing complex edge-assisted machine type task(s) (e.g., edge-assisted navigation) that can be a combination of different machine-type task(s) (e.g., object detection, object classification, object tracking, etc.).

The WTRU then activates context aware optimization process and/or generates the WTRU context (e.g., context information) related to the machine-type task execution. The context information may include application performance, such as achieved application round trip time (e.g., time span of the application data generation to the inference feedback reception from the remote server), application round trip time threshold(s), upper/lower bounds of data rate, data size, etc. The context information may include compute performance (e.g., compute delay, computation load, etc.). The context information may include machine-task performance (e.g., confidence level of inference, confidence thresholds of inference, false positives/negatives of inference decision, etc.). The context information may include upper NW layer performance (e.g., transport layer congestion, RLC buffer status, MAC buffer status, etc.). The context information may include WTRU performance related to the machine-task (e.g., collision probability, power consumption, battery level, etc.).

Next, the WTRU requests AI/ML-based context-aware optimization from the NW and transmits a configuration to the NW containing the complete WTRU context (e.g., the context information constructed in line with the discussion above), and/or an indication of when to trigger the context-aware optimization and for how long to execute the context-aware optimization. The WTRU may transmit this request (e.g., and/or the context information) via (e.g., new) MAC CE, uplink control information (UCI), or RRC.

The NW then receives the request from the WTRU(s) for context-aware optimization and transmits a corresponding acknowledgement to the WTRU(s). The NW proceeds with generating the NW context for serving the edge-assisted machine-type application(s), estimating the application current E2E QoS, and generating the complete context regarding the machine-type task performance.

The NW then performs the AI/ML based context-aware optimization to predict a NW and application configuration to achieve the custom E2E QoS for the configured duration (e.g., as requested by the application).

The NW then determines for a Tx occasion (e.g., or UL transmission, set of Tx occasions, UL transmissions, set of UL transmissions, etc.) whether to use legacy (e.g., or default) NW and application layer parameters or to use the context-aware optimized parameters across the NW and application layers, based on one or more of application task QoS requirements, WTRU environment, WTRU mobility, WTRU power consumption, wireless channel condition, current measured QoS, etc. The application task QoS requirements may be defined by upper/lower bounds of round-trip time thresholds, confidence thresholds, etc. The WTRU environment may be defined by WTRU location, number of objects near the WTRU, WTRU mobility, characteristics of objects around the WTRU (e.g., speed, direction, size, etc.), and/or atmospheric conditions (e.g., fog, low-light, sunny, etc.), that may affect the application performance. The wireless channel condition may be defined by CQI, RSSI, RSRP, SINR, pathloss, etc. The cross-NW layer parameters may be defined by the RLC, MAC, PHY, etc.

The NW then transmits an indication to the WTRU related to the usage of context aware optimized values. For example, the NW may transmit one or more of: an indication of a duration or a number of slots/frames/ms for which the context-aware optimized values (e.g., context-aware parameters) are determined to be valid (e.g., a validity period) based on the WTRU and/or NW context. The NW may transmit the indication of the usage of the context-aware parameter(s) via DCI, MAC CE, or RRC.

Based on the received configuration of the context-aware optimized values, the WTRU may then determine a configuration of the application layer(s) and/or the upper NW layer(s)

The WTRU may then transmit, in the UL, by using the context-aware optimized value(s) (e.g., to configure) the application and/or the upper NW layer(s) for the Tx occasion(s). For example, the WTRU may transmit a first UL transmission using the context-aware parameters during a first Tx occasion (e.g., time slot) and may transmit a second UL transmission using the default parameters during a second, different, Tx occasion (e.g., time slot, etc.).

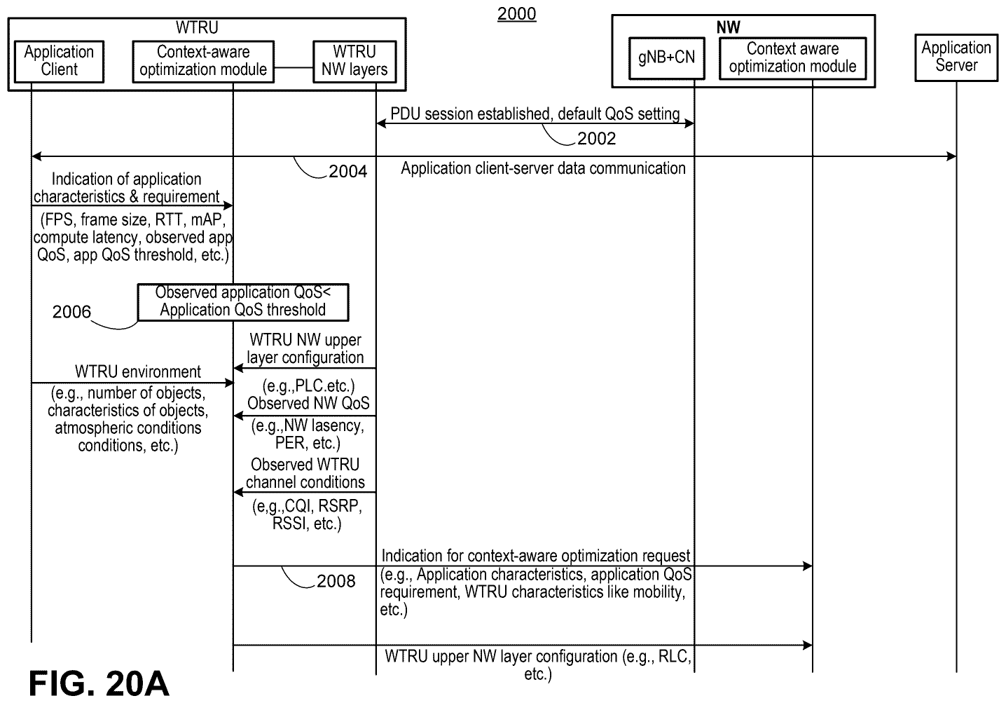

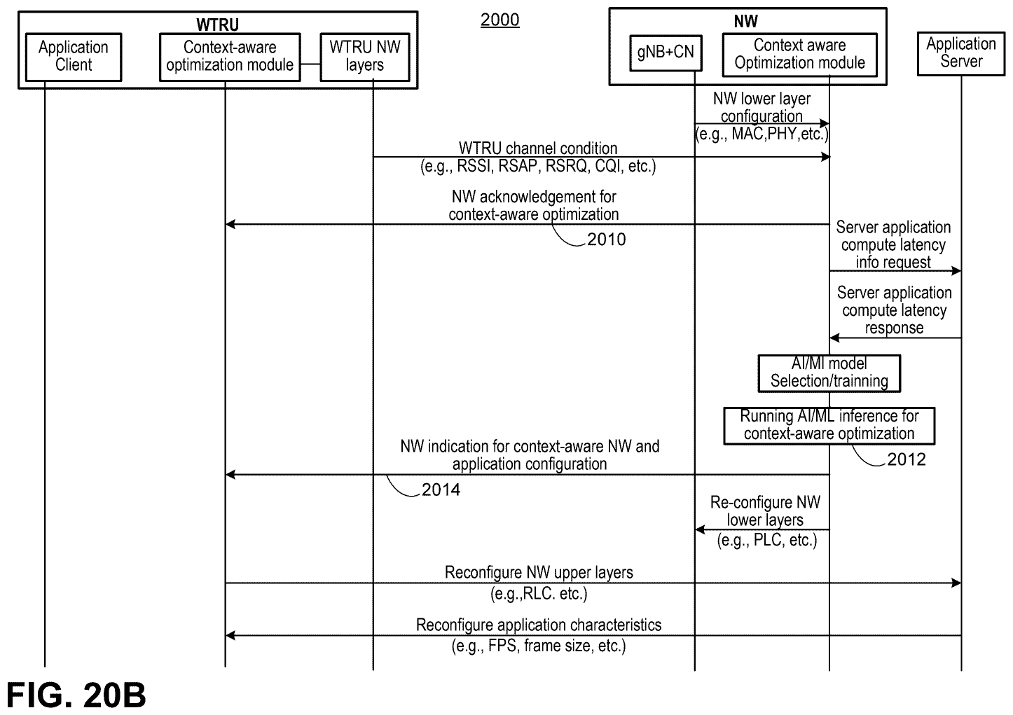

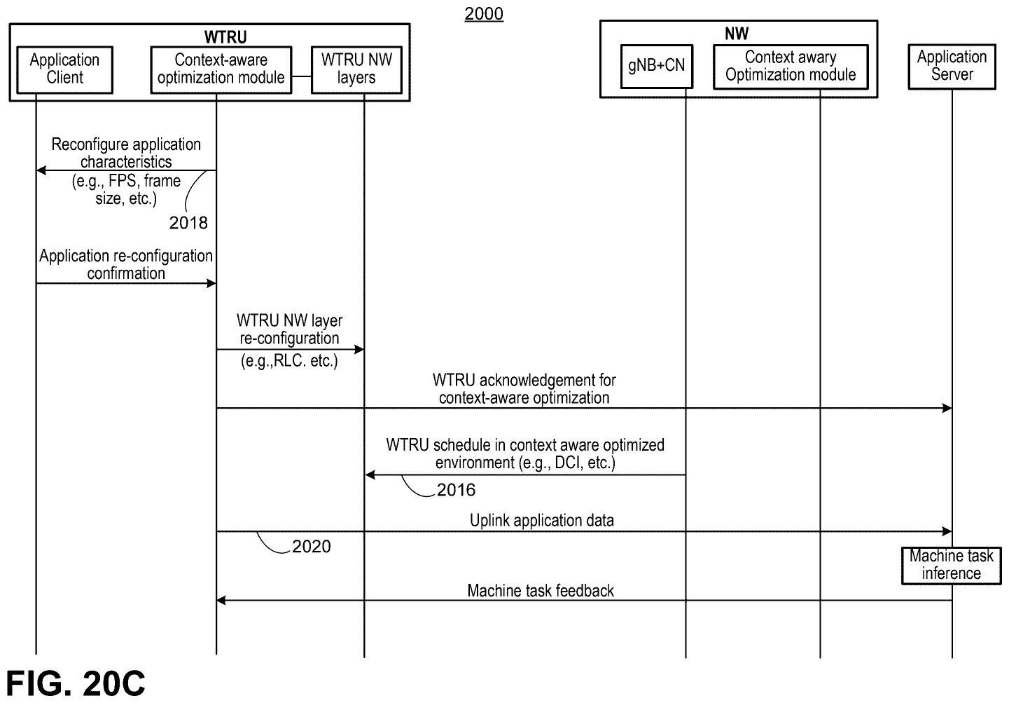

FIGS. 20A, 20B, 20C illustrate a flowchart of an example process 2000 that includes WTRU assisted context-aware optimization steps executed by a cellular network on the NW and application layers to accommodate dynamic and/or custom machine type application QoS requirements.

In the process 2000, a WTRU client machine-type application sets up a connection (operation 2002) with a remote server machine-type application and initiates data communication (operation 2004) for executing complex edge-assisted machine type task(s) (e.g., edge-assisted navigation). The edge-assisted machine type task(s) may include a combination of different machine-type task(s) (e.g., object detection, object classification, object tracking, etc.).

When the WTRU client MTC application initiates the edge-assisted UE machine-type task, for example, the WTRU may perform an initial access procedure to register with the NW. After registration, the WTRU initiates a PDU (Protocol Data Unit) session establishment by sending a ‘PDU Session Establishment Request’ to the NW, and/or indicating the required Quality of Service (QoS) parameters. Based on this request, the NW establishes one or more QoS flows within the PDU session, each with a specific QFI (QoS Flow Identifier), ensuring that they are treated according to the corresponding QoS profile in the 3GPP 5QI table (e.g., TS 23.501) throughout the network. The NW may map the QoS flows to appropriate radio bearers. Each radio bearer is configured with specific parameters such as modulation, coding schemes, and scheduling priorities to meet the desired QoS. After PDU session establishment, the NW may provide the WTRU with an IP address (or another network identifier) that it uses to communicate with external servers.

Next, in the process 2000, the WTRU activates context aware optimization process and/or generates (operation 2006) a WTRU context (e.g., context information) related to execution of a machine-type task associated with the MTC application. For example, the WTRU may determine the context information for execution of the MTC application. The context information may include application performance information, such as achieved application round trip time (e.g., time span of the application data generation to the inference feedback reception from the remote server), application round trip time threshold(s), upper/lower bounds of data rate, data size, etc. The context information may include compute performance (e.g., compute delay, computation load, etc.). The context information may include machine-task performance (e.g., confidence level of inference, confidence thresholds of inference, false positives/negatives of inference decision, etc.). The context information may include upper NW layer performance (e.g., transport layer congestion, RLC buffer status, MAC buffer status, etc.).

The context information may include WTRU performance related to the machine-task (e.g., collision probability, power consumption, battery level, etc.).

For example, the WTRU may monitor the machine-type application client and/or server performance when executing machine-type complex tasks (e.g., obstacle detection, obstacle classification, obstacle tracking, etc., for edge-assisted navigation) over the legacy (e.g., default) NW optimization parameters such as default QoS class for the application and/or the related PHY and MAC layer optimizations. The WTRU monitors the application characteristics such as data rate, data size and their upper and lower bounds and the impact of the application performance on the machine type task. For example, the WTRU may correlate application metrics such as data rate, data size, application packet drops, computation latency, local computation load, server compute load, round trip time from the moment of sensor data generation till the moment of inference feedback reception from server, etc. with the machine-type task performance metrics such as mean average precision for inference task, false positives/negatives of inference decision, etc. When the thresholds for the application QoS such as application packet drops, round trip time of application inference, etc., and/or machine-task QoS such as mean average precision, false positives/negatives of inference decision, etc., are not met, then the UE decides to activate the context-aware optimization process. An example goal of the context-aware optimization process is for the NW to provide custom optimized parameterization across the NW and application layers by having the full knowledge of the WTRU-provided context and the NW context for running the complex WTRU machine-type task (e.g., edge assisted navigation).

To generate WTRU context information regarding the machine-task in a real-world environment, the WTRU may gather information from both the application and the upper NW layers (e.g., RLC) that are active in the WTRU, and/or other multi-modal data available at the WTRU, such as (but not limited to) active machine type application and other legacy applications, WTRU upper NW layers that are facilitating the connection between the WTRU and the remote server that is running the inference, WTRU wireless channel characteristics, WTRU characteristics, and/or WTRU environment characteristics.

The WTRU may request, from the machine-type client and server application, the observed application QoS (e.g., computation load, computation latency, confidence level of inference like mean average precision, application round trip time from the moment of sensor data generation till the moment of inference feedback reception from server, etc.), the upper and lower bounds of application QoS thresholds (e.g., confidence thresholds of inference, round trip time thresholds between application client and server, etc.) that can be dynamic based on the WTRU environment (objects around the WTRU, object characteristics, mobility, WTRU location, etc.) and WTRU behavior (e.g., WTRU mobility, WTRU direction, etc.), and the application characteristics (e.g., upper and lower bounds of data rate, data size, etc.).

The WTRU may request information from the upper NW layers (e.g., RLC, etc.) that reside in the WTRU, regarding the active NW parameters, the upper and lower bounds of the upper NW layer parameters.

The WTRU may gather information about the observed NW QoS (e.g., NW latency, NW round trip time, NW packet error rate, NW throughput, NW bandwidth, etc.). The WTRU may gather information about the observed WTRU channel conditions (e.g., RSRP, CQI, RSSI, etc.) The WTRU may gather information about the WTRU characteristics and environment (e.g., WTRU mobility, UE mobility direction or heading, WTRU location, etc.). This various information gathered by the WTRU may provide the context on the WTRU side regarding the active machine-type application performance. To generate a more complete context regarding the performance of the WTRU machine-task aided by the edge-server based inference via the NW, the NW may generate a context of the NW performance as well and/or add the NW-generated context to the WTRU-generated context.

Next, in the process 2000, the WTRU requests (operation 2008) AI/ML-based context-aware optimization from the NW and transmits a configuration to the NW containing the (e.g., more complete) WTRU context constructed above (e.g., the context information). For example, the WTRU may send (e.g., to the NW) the context information (e.g., the WTRU context). The WTRU may also transmit an indication of when to trigger the context-aware optimization and/or for how long to execute the context-aware optimization. The WTRU may transmit the request via new MAC CE, UCI or RRC.

For example, the WTRU may transmit a configuration containing the gathered WTRU context (e.g., context information) to the NW and request context-aware optimization, that can meet the current machine-type application QoS thresholds. The WTRU may transmit this request via new MAC CE, UCI or L3 signaling. The WTRU may transmit a configuration associated with when to perform the context-aware optimization for the purpose of this invention. The configuration may include an immediate indication from the WTRU, in which case the NW executes the context-aware optimization immediately. Alternatively or additionally, the configuration may include a specific future timestamp for when to start the context aware optimization based on one or more of the characteristics of the objects in the WTRU environment (e.g., mobility of objects, WTRU mobility, etc.), WTRU machine-task requirement (e.g., object detection/classification/identification at a specific time, which can be a future time as well based on the application tracking and prediction of object location, etc.). The NW may receive threshold(s) (e.g., from the WTRU(s)) for measurements. The thresholds may relate to an upper/lower bound for the measurements, change rate over a certain time window, average values, etc. The threshold(s) may be either for application measurements (e.g., round trip time of sensor data generation to inference feedback, etc.) and/or for machine-task performance (e.g., false positives in object detection, etc.). The configuration may include information indicating how long the context-aware optimization is to be performed (e.g., a future time window that may be represented with an end time, a timer, a number of Tx occasions, a number of slots/frames, etc.), based on the WTRU characteristics (e.g., WTRU mobility, WTRU location, etc.), WTRU environment (e.g., mobility of objects around the WTRU, density of objects around the WTRU, WTRU atmospheric conditions, etc.), machine-type task requirements (e.g., one or more of object detection/classification/tracking/identification at a specific time instant or at a specific series of time instances, etc.).

Next, in the process 2000, the NW receives the request from the WTRU(s) for context-aware optimization and transmits a corresponding acknowledgement (operation 2010) to the WTRU(s). The NW may also generate a NW context for serving the edge-assisted machine-type application(s), estimate current E2E QoS for the application, and/or generate (e.g., a more complete) combined context information regarding the machine-type task performance.

The NW proceeds with generating the complete context about the machine-type application. For this purpose, the NW may first generate the NW context corresponding to the duration of time that is covered by the WTRU context. The NW context may include parameters of the lower layers of the NW (e.g., MAC, PHY, etc.) that are controlled by the NW. The NW context may include upper and lower bounds of the parameters for the lower layers of the NW. The NW context may include actual NW bandwidth and the corresponding upper and lower bounds. The NW context may include information about performance of the server that is running the application endpoint (e.g., server computation load, server latency to the NW, etc.).

The NW may then combine the NW context with the WTRU context to generate a (e.g., more) complete context regarding the machine-type application performance. For example, the complete context may enable the NW to get a birds-eye view of the E2E processes linked with each other and are together executing the machine-type task. This birds-eye view comprises of but is not limited to client application configuration(s), client application characteristics, client application performance, WTRU characteristics, NW configuration across one or more (e.g., or all) NW layers, NW performance, server application configuration, server application characteristics, server application performance, etc. This information may enable the network to generate the complete context regarding the machine-type task performance.

Next, in the process 2000, the NW performs AI/ML based context-aware optimization (operation 2012) to predict a NW and application configuration to achieve the custom E2E QoS for the configured duration (e.g., as requested by the application).

The NW triggers the AI/ML based context-aware optimization across the NW and application layers for the configured duration (e.g., and/or the determined configuration described above). The NW may maintain a set of AI/ML models that are trained on specific UE application configurations, WTRU characteristics, and/or NW configurations. Based on the current WTRU and NW context for executing the machine-type application, the NW may select the most capable AI/ML model (e.g., the model that generated the highest rewards during training on the similar configuration and/or scenario) for context-aware optimization.

The context-aware optimization parameters may include one or more of NW PHY layer configuration (e.g., number of uplink and downlink slots in a PHY frame, transmit power, bandwidth, time division duplexing, frequency division duplexing, time domain resource allocation, frequency domain resource allocation, etc.), NW MAC layer configuration (e.g., NW MAC scheduling, UE MAC buffer configuration, etc.), WTRU RLC layer configuration (e.g., data priority, data buffer, buffer size, etc.), other NW layer configuration (e.g., TCP/UDP, RTP, etc.), and/or application layer configuration (e.g., data rate, data compression, data priority, etc.).

The NW may execute the context-aware optimization based on one or more of a trained AI/ML model (e.g., trained for the current configuration and/or scenario), a WTRU scenario (e.g., current speed, current location, current direction of mobility, predicted speed, predicted location, predicted direction of mobility, environment, active machine-task(s), etc.), WTRU configuration (e.g., computation capability, battery level, battery consumption, number of Tx/Rx antennas, Tx/Rx antenna pattern, etc.), current client application configuration, client application characteristics, client application performance, NW configuration across all the NW layers, NW performance, server application configuration, server application characteristics, and/or server application performance, etc.

The NW may determine the duration for which context-aware optimized values are valid. For example, the NW may determine a duration to be the maximum duration for which the machine-type task QoS and/or the application QoS are stable or consistent. The duration may be limited by a configurable maximum duration value. The context-aware optimized values may be considered stable or consistent based on at least one of the variance of the application QoS and/or the machine-type task QoS during a duration is less than a threshold amount, the difference between a maximum QoS value and minimum QoS value for either the application and/or the machine-task is less than a threshold amount, and/or the rate of change between two or more QoS values for either the application and/or the machine-task is less than a threshold amount.

Next, in the process 2000, the NW determines for a Tx occasion (e.g., UL transmission, set of Tx occasions, UL transmissions, or set of UL transmissions) whether to use the legacy (e.g., default) NW and application layer parameters or the context-aware optimized parameters across the NW and application layers (operation 2014). The NW may determine whether to use the default or the context-aware parameters based on one or more of application task QoS requirements, WTRU environment, WTRU mobility, WTRU power consumption, wireless channel condition, current measured QoS, etc. the application task QoS requirements may be defined by upper/lower bounds of round-trip time thresholds, confidence thresholds, etc. The WTRU environment may be defined by WTRU location, number of objects near the WTRU, WTRU mobility, characteristics of objects around the UE like speed, direction, size, etc., atmospheric conditions like fog, low-light, sunny, etc., that may affect the application performance. The wireless channel condition may be defined by CQI, RSSI, RSRP, SINR, pathloss, etc. The cross-NW layer parameters may be defined by the RLC, MAC, PHY, etc.

The NW may learn for which scenarios of WTRU and NW context the machine-type application QoS and/or machine-type task QoS thresholds are not met. For example, a required machine-type application round trip time threshold and/or machine-task inference confidence threshold may not be met for specific combination(s) of WTRU context like WTRU application characteristics (e.g., data rate, data size, etc.), WTRU characteristics (e.g., mobility, location), WTRU environment (e.g., atmospheric conditions, mobility of objects, etc.) and NW context like NW configuration (e.g., MAC, PHY, etc.), channel conditions, etc.

The NW may check if the configured criteria (e.g., related to when to trigger predictions, how long, etc.,) indicated in the WTRU context and/or the NW context is met.

Based on the WTRU context received from the WTRU, the NW may determine thresholds of the application round trip time, machine task inference confidence thresholds, etc., according to WTRU environment conditions. Based on the NW context determined at the NW, the NW may also determine the current channel conditions (e.g., CQI, RSSI, RSRP, SINR, pathloss, etc.) and the relevant statistical metrics (e.g., average values, min/max values, drop rate, growth rate, change rate, and/or deviation from a median value, etc.). These metrics may help in the definition of a classification for the channel conditions, for example, because they represent the way the channel is changing. The NW could thus use the metrics and/or current channel conditions to facilitate classification of channel stability (e.g., stable vs unstable, very low stability, low stability, medium stability, high stability, very high stability, etc.).

If the current WTRU context includes an explicit indication of context-aware optimization and/or if the NW determines (e.g., based on learning or determining that the current WTRU context and NW context does not satisfy the current machine-type application QoS and/or the machine-type task QoS for the full duration or part of the duration of the Tx occasions that is covered by the WTRU context), then the NW may identify one or more specific Tx occasions as suitable candidates for context-aware optimization.

Next, in the process 2000, the NW transmits (operation 2016) an indication to the WTRU related to the usage of context aware optimized values. For example, the NW may transmit one or more of: an indication of duration or the number of slots/frames/ms for which the context-aware optimized values are determined to be valid (e.g., a validity period), based on the WTRU and NW context. The NW may transmit this indication via DCI, MAC CE, or RRC. Thus, for example, the WTRU may receive (e.g., from the NW) the one or more context-aware parameters and the information related to the usage of the one or more context-aware parameters.

For example, the NW may transmit an indication to the WTRU including one or more of: context-aware optimized values (e.g., context-aware parameters) for a machine-type application configuration (e.g., data rate, data size, etc.) or an upper NW layer configuration for the WTRU (e.g., RTP, TCP/UDP, RLC, etc.), the duration for which the current context-aware optimized values are valid (e.g., number of slots/frames/ms), and/or statistics associated with one or more context-aware optimized values (e.g., RLC buffer size, data rate, data size, etc.). The transmitted indication may include a maximum or minimum context-aware optimized change rate, for example, and/or a maximum or minimum context-aware optimized value. The NW may transmit this indication to the WTRU and may include any of the additional information via DCI, MAC CE, and/or RRC. The NW may transmit the indication in a PDCCH or PDSCH transmission. The PDCCH or PDSCH transmission may be performed using the context-aware optimized NW layer parameters. Alternatively, the PDCCH or PDSCH transmission may be performed using the legacy (e.g., default) NW layer parameters.

The NW may be triggered to indicate the context-aware optimized values based on at least one of a change in WTRU and/or NW context (e.g., if the WTRU and/or NW context differs from a previously reported WTRU and/or NW context by more than a threshold amount, time (e.g., the NW may be configured to indicate the context-aware optimized values periodically to the WTRU, and/or the NW may transmit a new indication of context-aware optimized values to the WTRU after every configured or NW-determined duration), and/or WTRU request. For example, the WTRU may send a request for the NW to provide context-aware optimized values periodically or aperiodically. The request may be received by the NW in a UCI or MAC CE or RRC.

Next, in the process 2000, the WTRU implements (operation 2018) the configuration of the application layer(s) and/or the upper NW layer(s) based on the received configuration of the context-aware optimized values. For example, the WTRU may determine a configuration for at least one of an application layer or an upper network (NW) layer based on the received information (e.g., the context-aware parameters and/or the information related to usage of the context-aware parameters). In some examples, the WTRU implements the received configuration for the application layer parameters and/or the upper NW layer parameters (e.g., RLC, transport layer, etc.) before initiating machine-type application data communication.

Next, in the process 2000, the WTRU transmits (operation 2020) in the UL using the context-aware optimized value(s) in the application and/or the upper NW layers for one or more Tx occasion(s). For example, the WTRU transmits a first UL transmission using the context-aware parameters at a first time (e.g., based on the received configuration) and transmits a second UL transmission using the default parameters (e.g., legacy parameters) at a second time depending on the configuration of the application and/or upper NW layer(s) indicated in the configuration for the usage of the context-aware parameters. Thus, in some examples, the WTRU transmits using the context-aware optimized value(s), in the application and/or the upper NW layers for certain Tx occasion(s). For example, the WTRU may indicate (e.g., for each particular UL transmission or for a set of UL transmissions, etc.) whether the UL transmission uses context-aware optimized values or default values for the application and/or NW layer(s).

What is claimed:

1. A method performed by a Wireless Transmit/Receive Unit (WTRU), the method comprising:
determining context information for execution of an edge-assisted task associated with a machine-type-communications (MTC) application, wherein the context information indicates one or more of performance of the MTC application or performance of the edge-assisted task;
sending the context information;
receiving one or more context-aware parameters and information related to usage of the one or more context-aware parameters;
based on the received information, determining a configuration for at least one of an application layer or an upper network (NW) layer; and
based on the determined configuration, sending a first uplink (UL) transmission using the one or more context-aware parameters for the application layer or the upper NW layer.

2. The method of claim 1, further comprising:
based on the determined configuration, sending a second UL transmission using one or more default parameters for the application layer or the upper NW layer.

3. The method of claim 1, wherein the context information indicates a request for machine learning based context-aware optimization for the MTC application.

4. The method of claim 1, further comprising:
sending a request for machine learning based (ML-based) context-aware optimization for the MTC application, wherein receiving the one or more context-aware parameters is in response to sending the request.

5. The method of claim 4, further comprising:
sending an indication of at least one of: when to trigger the ML-based context-aware optimization, or a requested duration for the ML-based context-aware optimization.

6. The method of claim 1, wherein the received information indicates at least one of a duration or a number of slots for applying the one or more context-aware parameters.

7. The method of claim 1, wherein receiving the information is via downlink control information (DCI), a medium access control control element (MAC CE), or radio resource control (RRC) signaling.

8. The method of claim 1, wherein the received information further indicates whether to use the one or more context-aware parameters or one or more default parameters for the first UL transmission based on one or more of application task quality of service (QoS) requirements, WTRU environment, WTRU mobility, WTRU power consumption, wireless channel condition, or measured QoS indicated in the context information.

9. The method of claim 1, wherein the one or more context-aware parameters are associated with a predicted application configuration to achieve an end-to-end (E2E) quality of service (QoS) for a requested duration indicated by the context information.

10. The method of claim 1, wherein sending the first UL transmission is based on using the one or more context-aware parameters in the application layer and one or more upper NW layers.

11. The method of claim 1, further comprising executing the edge-assisted task.

12. The method of claim 1, wherein the performance of the MTC application includes at least one of a time span from data generation to inference feedback, a threshold for the time span, an upper bound of a data rate, a lower bound of the data rate, or a data size.

13. The method of claim 1, wherein the performance of the edge-assisted task includes at least one of an inference confidence level, an inference confidence threshold, or false positives associated with inference decisions.

14. The method of claim 1, wherein the context information further indicates one or more of compute performance, network (NW) layer performance, or WTRU performance.

15. The method of claim 1, wherein the one or more context-aware parameters include one or more NW layer configuration parameters or one or more application layer configuration parameters.

16. The method of claim 15, wherein the one or more NW layer configuration parameters comprise one or more of: number of uplink slots in a physical layer (PHY) frame, number of downlink slots in the PHY frame, transmit power, bandwidth, time division duplexing, frequency division duplexing, time domain resource allocation, or frequency domain resource allocation, and
wherein the one or more application layer configuration parameters comprise one or more of: data rate, data compression, or data priority.

17. A Wireless Transmit/Receive Unit (WTRU) comprising:
a processor configured to:
determine context information for execution of an edge-assisted task associated with a machine-type-communications (MTC) application, wherein the context information indicates one or more of performance of the MTC application or performance of the edge-assisted task;
send the context information;
receive one or more context-aware parameters and information related to usage of the one or more context-aware parameters;
based on the received information, determine a configuration for at least one of an application layer or an upper network (NW) layer; and
based on the determined configuration, send a first uplink (UL) transmission using the one or more context-aware parameters for the application layer or the upper NW layer.

18. The WTRU of claim 17, wherein the processor is further configured to:
based on the determined configuration, send a second UL transmission using one or more default parameters for the application layer or the upper NW layer.

19. The WTRU of claim 17, wherein the context information indicates a request for machine learning based context-aware optimization for the MTC application.

20. The WTRU of claim 17, wherein the processor is further configured to:
send a request for machine learning based (ML-based) context-aware optimization for the MTC application, wherein receiving the one or more context-aware parameters is in response to sending the request.
